(19) United States
(12) Patent Application Publication
(10) Pub. No.: US 2025/0027183 A1
(43) Pub. Date: Jan. 23, 2025

(54) PROCESSING OF MINING FEEDSTOCKS USING KINETIC PULVERIZATION AND SEPARATION

(71) Applicant: TORXX KINETIC PULVERIZER LIMITED, Hamilton (BM)

(72) Inventors: Christopher Mueller, Hamilton (BM); Michael Drolet, Hamilton (BM); Peter Everson, Hamilton (BM); Terri Ward, Hamilton (BM); Doulgas Coyle, Hamilton (BM)

(73) Assignee: TORXX KINETIC PULVERIZER LIMITED, Hamilton (BM)

(21) Appl. No.: 18/840,780

(22) PCT Filed: Feb. 24, 2023
(86) PCT No.: PCT/CA2023/050238

§ 371 Date: Aug. 22, 2024

(30) Foreign Application Priority Data
Feb. 25, 2022 (CA) 3150178

(51) Int. Cl. C22B 26/12; B02C 19/00; B02C 23/10; C22B 1/00; C22B 3/04

(52) U.S. Cl. CPC C22B 26/12; B02C 19/005; B02C 23/10; C22B 1/00; C22B 3/04

(57) ABSTRACT

The present document related to the processing of mining materials, such as ores, rocks, minerals, and aggregate materials to separate valuable components. There is provided a process and system for extracting a valuable component from a mining feedstock comprising geological materials. The process can comprise subjecting the mining feedstock to a kinetic pulverization stage wherein the mining feedstock is subjected to self-collisions created by vortices within the kinetic pulverizer to produce a pulverized material; admixing the mining feedstock or the pulverized material with a chemical additive configured to selectively liberate the valuable component from the geological material; and subjecting the pulverized material to an extraction stage to produce a valuable component-rich stream and a valuable component-depleted stream. There is also provided processes for producing a homogenous mixture of a geological material derived from a mining feedstock and an additive, as well as processes for mechanochemically processing a raw material.

The technical field generally relates to the processing of mining materials, such as ores, rocks, minerals, and aggregate materials to separate valuable components.

### BACKGROUND

Various materials can be mined and processed to extract valuable components. Processing of such mined feedstocks can include size reduction and separation methods. There are various challenges involved in processing mined materials and there is a need for technologies that overcome at least some of such challenges.

### SUMMARY

It is therefore an aim of the present invention to address the above mentioned issues.

According to a general aspect, there is provided a process for extracting a valuable component from a mining feedstock comprising geological materials embedded with the valuable component, the process comprising: subjecting the mining feedstock to a kinetic pulverization stage wherein the mining feedstock is fed into a kinetic pulverizer and subjected to self-collisions created by vortices within the kinetic pulverizer to produce a pulverized material; admixing the mining feedstock or the pulverized material with a chemical additive configured to selectively liberate the valuable component from the geological material; and subjecting the pulverized material to an extraction stage to produce a valuable component-rich stream and a valuable component-depleted stream.

In some embodiments, the chemical additive comprises a cation source configured to undergo ion-exchange with the valuable component.

In some embodiments, the chemical additive comprises a salt compound.

In some embodiments, the chemical additive is selected from the group consisting of NaCl, PCl₃, KCl, Na₂SO₄, K₂SO₄, MgSO₄, CaSO₄, NaNO₃, KNO₃, CaCl₂), MgCl₂, Ca(NO₃)₂, and Mg(NO₃)₂.

In some embodiments, the chemical additive is NaCl.

In some embodiments, wherein the chemical additive is admixed with the mining feedstock concurrently with or before the mining feedstock is subjected to the kinetic pulverization stage.

In some embodiments, the chemical additive is introduced directly into the kinetic pulverizer concurrently with the mining feedstock and as a separate stream from the mining feedstock.

In some embodiments, the chemical additive is homogenized with the mining feedstock to form part of the pulverized material.

In some embodiments, the chemical additive is admixed with the pulverized material after the mining feedstock is subjected to the kinetic pulverization stage.

In some embodiments, a leaching liquid is introduced to at least one of: the mining feedstock, the kinetic pulverizer, the pulverized material, and the chemical additive.

In some embodiments, the leaching liquid is introduced to at least one of the chemical additive, the kinetic pulverizer, and the mining feedstock at least one of: concurrently with and before the mining feedstock is subjected to the kinetic pulverization stage.

In some embodiments, the leaching liquid is introduced directly into the kinetic pulverizer concurrently with the mining feedstock and as a separate leach stream from the mining feedstock.

In some embodiments, the leaching liquid is introduced to at least one of: the chemical additive and the pulverized material after the mining feedstock is subjected to the kinetic pulverization stage.

In some embodiments, the extraction stage comprises subjecting the pulverized stream to a leaching stage.

In some embodiments, the leaching stage comprises separating the valuable component-rich stream from the valuable component-depleted stream.

In some embodiments, the valuable component-rich stream is separated from the valuable component-depleted stream with a mechanical screen.

In some embodiments, the mechanical screen is a trommel screen.

In some embodiments, the mechanical screen is a tumbler screen.

In some embodiments, the mechanical screen is a vibrating screen.

In some embodiments, the mechanical screen is a gyratory screen.

In some embodiments, the mechanical screen is a high frequency screen.

In some embodiments, the mechanical screen is classification equipment.

In some embodiments, the classification equipment is an air classifier.

In some embodiments, the classification equipment is a hydrocyclone.

In some embodiments, wherein the valuable component-rich stream is separated from the valuable component-depleted stream with a filter.

In some embodiments, the process further comprises agitating a mixture of the pulverized material and the chemical additive with the leaching liquid to produce the valuable component-rich stream.

In some embodiments, said agitation comprises agitation at a temperature between 60° C. and 100° C.

In some embodiments, said agitation comprises agitation at between 800 rpm and 1200 rpm.

In some embodiments, said agitation comprises agitation for at least 10 minutes.

In some embodiments, the extraction stage further comprises subjecting the valuable component-rich stream to a recovery stage to recover the valuable component.

In some embodiments, the kinetic pulverization stage is conducted in an inert environment.

In some embodiments, the chemical additive is admixed with the mining feedstock or the pulverized material in an inert environment.

In some embodiments, the inert environment substantially comprises a hypoxic environment.

In some embodiments, the inert environment comprises nitrogen gas.

In some embodiments, the mining feedstock comprises at least one of ore, rocks, minerals, slag, clinker, petroleum coke, clay minerals, and soil minerals.

In some embodiments, the valuable component comprises at least one of lithium, sodium, potassium, aluminum, silicon, magnesium, calcium, iron, nickel, and oxygen.

In some embodiments, the valuable component comprises graphene.

In some embodiments, the valuable component comprises rare earth minerals.

In some embodiments, the rare earth minerals comprise at least one of neodymium, yttrium, cerium, scandium, lanthanum, praseodymium, promethium, samarium, europium, gadolinium, terbium, dysprosium, holmium, erbium, thulium, ytterbium, and lutetium.

In some embodiments, the mining feedstock comprises a lithium-rich clay mineral.

In some embodiments, the valuable component is lithium.

In some embodiments, the mining feedstock comprises material below 12 inches in size.

In some embodiments, the mining feedstock comprises material below 6 inches in size.

In some embodiments, the mining feedstock comprises material between about 1 inch and about 4 inches in size.

In some embodiments, the kinetic pulverizer is operated at a rotation speed between 500 RPM to 1,500 RPM.

In some embodiments, the kinetic pulverizer is operated at a rotation speed between 700 RPM and 1,000 RPM.

In some embodiments, the kinetic pulverizer is operated such that the pulverized material is substantially sand or silt sized particles.

In some embodiments, the kinetic pulverizer is operated such that the pulverized material is substantially micron sized particles.

In some embodiments, the kinetic pulverizer is operated such that the pulverized material is substantially sub-micron sized particles.

In some embodiments, the mining feedstock has a moisture content between 10% and 50% upon entry into the kinetic pulverizer.

In some embodiments, the mining feedstock has a moisture content between 15% and 40% upon entry into the kinetic pulverizer.

In some embodiments, the pulverized material is a homogeneous mixture in a pulverized output stream.

In some embodiments, the process further comprises introducing a friable additive into the mining feedstock such that the friable additive is size reduced and homogenized with the mining feedstock to form part of the pulverized material.

In some embodiments, the friable additive and the chemical additive are pulverized and homogenized in the kinetic pulverizer concurrently with the mining feedstock.

In some embodiments, the friable additive is introduced into the mining feedstock upstream of the kinetic pulverization stage.

In some embodiments, the friable additive is introduced directly into the kinetic pulverizer as a separate friable stream from the mining feedstock.

In some embodiments, the process further comprises subjecting the mining feedstock to a pre-treatment stage prior to the kinetic pulverization stage.

In some embodiments, the pre-treatment stage is a magnetic separation stage that separates ferrous material from the mining feedstock before the mining feedstock is subjected to the kinetic pulverization stage.

In some embodiments, the magnetic separation stage is performed by one or more magnetic separators configured relative to a feed of the mining feedstock.

In some embodiments, the pre-treatment stage comprises at least one of: a coarse sizing stage, a chemical addition stage, a drying stage, and a debris separation stage.

In some embodiments, the process further comprises subjecting the pulverized material to a post-treatment stage.

In some embodiments, the post-treatment stage comprises at least one of: a chemical addition stage, a heating stage, a debris separation stage, an electrostatic separation stage, a dust collection stage, and a secondary size-reduction stage.

In some embodiments, the dust collection stage comprises recovering a dust fraction therefrom and producing a dust reduced pulverized stream.

In some embodiments, the dust reduced pulverized stream is subjected to the extraction stage, and optionally the dust fraction is also recovered and fed to the extraction stage.

In some embodiments, the electrostatic separation stage comprises electrostatically separating particulate material from the pulverized material.

In some embodiments, the secondary size-reduction stage comprises subjecting the pulverized material to a size reduction machine.

In some embodiments, the size reduction machine comprises at least one of a ball mill, an oscillating motion mill, a hammer mill, a high shear energy mill, a vibratory mill, an attritor mill, a crusher, and a grinding mill.

In some embodiments, the debris separation stage comprises subjecting the pulverized material to flotation separation.

In some embodiments, the process further comprises: monitoring at least one of: at least one feed parameter of the mining feedstock; and at least one output parameter of the pulverized material; and adjusting the kinetic pulverization stage based on at least one of: the at least one feed parameter and the at least one output parameter.

In some embodiments, the at least one feed parameter comprises at least one of a feed rate of the mining feedstock, a moisture content of the mining feedstock, and a composition of the mining feedstock.

In some embodiments, the at least one output parameter comprises at least one of: size properties of the pulverized material, a composition of the pulverized material, a moisture content of the pulverized material, a flow rate of the pulverized material, and a composition of the pulverized material.

In some embodiments, the adjusting of the kinetic pulverization stage comprises adjusting a rotation speed of the kinetic pulverizer.

In some embodiments, the adjusting of the kinetic pulverization stage comprises adjusting an infeed rate of the mining feedstock into the kinetic pulverizer.

According to another aspect, there is provided a process for producing a pulverized material comprising a homogenous mixture of a geological material derived from a mining feedstock and an additive, comprising: providing the mining feedstock comprising the geological material; admixing the additive with the mining feedstock; subjecting the mining feedstock to a kinetic pulverization stage wherein the mining feedstock is fed into a kinetic pulverizer and subjected to self-collisions created by vortices within the kinetic pulverizer to produce the homogenous mixture of the geological material and the additive; and withdrawing the homogenous mixture from the kinetic pulverizer; wherein the additive is admixed with the mining feedstock concurrently with or before the kinetic pulverization stage.

In some embodiments, the additive is introduced into the mining feedstock upstream of the kinetic pulverization stage.

In some embodiments, the additive is introduced directly into the kinetic pulverizer as a separate additive stream from the mining feedstock.

In some embodiments, the process further comprises admixing a friable additive with the mining feedstock concurrently with or before the kinetic pulverization stage for size reduction and homogenization with the geological material.

In some embodiments, the friable additive is introduced into the mining feedstock upstream of the kinetic pulverization stage.

In some embodiments, the friable additive is introduced directly into the kinetic pulverizer as a separate friable stream from the mining feedstock.

In some embodiments, the process further comprises subjecting the mining feedstock to a magnetic separation stage prior to the kinetic pulverization stage to remove ferrous metal therefrom and produce a metal depleted feed stream that is fed to the kinetic pulverization stage.

In some embodiments, the magnetic separation is performed by one or more magnetic separators configured relative to a feed of the mining feedstock.

In some embodiments, the process further comprises subjecting the pulverized material to a dust collection stage to recover a dust fraction therefrom and produce a dust reduced pulverized stream.

In some embodiments, at least a portion of the dust fraction is combined with at least a portion of the dust reduced pulverized stream.

In some embodiments, all of the dust fraction is combined with the dust reduced pulverized stream.

In some embodiments, the dust reduced pulverized stream, the dust fraction or both, is subjected to an extraction stage to extract at least one valuable component therefrom.

In some embodiments, the dust collection stage comprises: a dust collector coupled with respect to an outlet of the kinetic pulverization stage or with respect to a solids transport device configured for transporting the pulverized material away from the kinetic pulverization stage; and a dust recovery unit coupled to the dust collector and configured to cause separation of the dust fraction and transport of the dust fraction from the dust collector to a storage vessel.

In some embodiments, the dust collector comprises a settling chamber.

In some embodiments, the dust recovery unit comprises a baghouse that is in fluid communication via ducting with the settling chamber.

In some embodiments, the dust recovery unit comprises a cyclone that is in fluid communication via ducting with the settling chamber.

In some embodiments, the solids transport device comprises a conveyor.

In some embodiments, the dust collector surrounds the solids transport device along a majority of a length thereof.

In some embodiments, the geological material is clinker.

In some embodiments, the additive is gypsum.

According to another aspect, there is provided a system comprising: a kinetic pulverizer configured to receive and process a mining feedstock comprising a geological material to produce a pulverized material; a treatment unit for treating the mining feedstock, the pulverized material, and/or material within the kinetic pulverizer, the treatment unit being configured for: incorporating a chemical additive, a leaching liquid, and/or a friable additive; subjecting the mining feedstock to a pre-treatment; and/or subjecting the pulverized material to a post-treatment; a pulverizer conveyor system configured to transport the pulverized material downstream; and an extraction unit configured to receive the pulverized material from the pulverizer conveyor system and extract a valuable component therefrom.

In some embodiments, the treatment unit is a chemical addition unit configured to incorporate the chemical additive into at least one of the mining feedstock and the pulverized material.

In some embodiments, the extraction unit comprises: a leaching unit configured to receive the pulverized material, incorporate the leaching liquid into the pulverized material and to produce a leachate comprising the valuable component and a depleted material rich in solids; and a recovery unit configured to receive the leachate from the leaching unit and produce a valuable component product and a depleted leaching liquid that can be optionally recycled back into the leaching unit.

In some embodiments, the recovery unit is configured to cause crystallization of the valuable component in the leachate.

In some embodiments, depleted leaching liquid is treated and recycled back into the leaching unit.

In some embodiments, the recovery unit further comprises a screen to remove the valuable component in solid form from the leachate.

In some embodiments, the kinetic pulverizer is configured for operation at a rotation speed between 500 RPM to 1,500 RPM.

In some embodiments, the kinetic pulverizer is configured for operation at a rotation speed between 700 RPM and 1,000 RPM.

In some embodiments, the system further comprises: a monitoring unit configured for monitoring at least one of: at least one feed parameter of the mining feedstock; and at least one output parameter of the pulverized material; and a control unit coupled to the monitoring unit and configured for adjusting the kinetic pulverizer based on at least one of: the feed parameter and the output parameter.

In some embodiments, the monitoring unit and the control unit are configured such that the at least one feed parameter comprises at least one of: a feed rate of the mining feedstock, a moisture content of the mining feedstock, a composition of the mining feedstock, and a feed rate of at least one unit.

In some embodiments, the control unit is configured to adjust the rotation speed of the kinetic pulverizer.

In some embodiments, the control unit is configured to adjust an infeed rate of the mining feedstock into the kinetic pulverizer.

In some embodiments, the treatment unit comprises a magnetic separator for pre-treatment to remove ferrous metal from the mining feedstock and produce a metal depleted feed stream that is fed to the kinetic pulverizer.

In some embodiments, the treatment unit comprises a dust collection unit for post-treatment to recover a dust fraction from the pulverized material and produce a dust reduced pulverized stream.

In some embodiments, the dust collection unit comprises: a dust collector coupled with respect to an outlet of the kinetic pulverizer or with respect to the pulverizer conveyor; and a dust recovery unit coupled to the dust collector and configured to cause separation of the dust and transport of the dust fraction from the dust collector to a storage vessel.

In some embodiments, the dust collector comprises a settling chamber.

In some embodiments, the dust recovery unit comprises a baghouse that is in fluid communication via ducting with the settling chamber.

In some embodiments, the dust recovery unit comprises a cyclone that is in fluid communication via ducting with the settling chamber.

In some embodiments, the dust collector surrounds the pulverizer conveyor system along a majority of a length thereof.

In some embodiments, the system further comprises an inerting system operatively coupled to at least one of: the kinetic pulverizer, the pulverizer conveyor system, the treatment unit, and the extraction unit.

In some embodiments, the inerting system is configured to provide hypoxic conditions.

In some embodiments, the inerting system is configured to provide nitrogen gas for the inerting.

According to another aspect, there is provided a process for mechanochemically processing a raw material, comprising: providing a mining feedstock comprising the raw material; and subjecting the mining feedstock to a kinetic pulverization stage wherein the mining feedstock is fed into a kinetic pulverizer and subjected to self-collisions created by vortices within the kinetic pulverizer to produce a pulverized material, and operating the kinetic pulverizer to convert the raw material into a mechanochemically modified material; withdrawing the pulverized material from the kinetic pulverizer, wherein the pulverized material comprises the mechanochemically modified material and a sized reduced matrix fraction; and separating the mechanochemically modified material from the sized reduced matrix fraction.

In some embodiments, the mechanochemically modified material comprises metallic nanoparticles, catalysts, magnets, y-graphyne, metal iodates, nickel-vanadium carbide and molybdenum-vanadium carbide nanocomposite powders.

In some embodiments, the mining feedstock comprises clay minerals that form part of the sized reduced matrix fraction after pulverization.

According to another aspect, there is provided a process for extracting a valuable component from a mining feedstock, the process comprising: subjecting the mining feedstock to a kinetic pulverization stage wherein the mining feedstock is fed into a kinetic pulverizer and subjected to self-collisions created by vortices within the kinetic pulverizer to produce a pulverized material; and extracting a liberated valuable component from the pulverized material with a leaching liquid.

According to another aspect, there is provided a process for extracting a valuable component from a mining feedstock, the process comprising: subjecting the mining feedstock to a kinetic pulverization stage wherein the mining feedstock is fed into a kinetic pulverizer and subjected to self-collisions created by vortices within the kinetic pulverizer to produce a pulverized material; contacting at least one of: the mining feedstock and the pulverized material with a chemical additive to selectively liberate the valuable component from size-reduced matrix material; and separating a liberated valuable component from the size-reduced matrix material of the pulverized material.

In some embodiments, the kinetic pulverization stage is a one pass kinetic pulverization stage.

In some embodiments, the kinetic pulverization stage is a multi-pass kinetic pulverization stage wherein the pulverized material is subjected to a second pulverization stage in the kinetic pulverizer or in a second kinetic pulverizer.

In some embodiments, the process further comprises subjecting the pulverized material to a secondary size-reduction stage to produce a treated sized material.

In some embodiments, the secondary size-reduction stage comprises subjecting the pulverization material to a secondary size-reduction machine.

In some embodiments, the size reduction machine comprises at least one of a ball mill, an oscillating motion mill, a hammer mill, a high shear energy mill, a vibratory mill, an attritor mill, a crusher, and a grinding mill.

In some embodiments, the chemical additive is contacted with the mining feedstock concurrently with or before the mining feedstock is subjected to the kinetic pulverization stage.

In some embodiments, wherein contacting at least one of the mining feedstock and the pulverized material with the chemical additive comprises at least one of: introducing the chemical additive directly into the kinetic pulverizer concurrently with the mining feedstock and as a separate stream from the mining feedstock; homogenizing the chemical additive with the mining feedstock to form part of the pulverized material;

and admixing the chemical additive with the pulverized material after the mining feedstock is subjected to the kinetic pulverization stage.

In some embodiments, the process further comprises agitating a mixture of the pulverized material and the chemical additive with a leaching liquid to produce the valuable component-rich stream.

In some embodiments, separating the liberated valuable component from the size-reduced matrix material comprises subjecting the size-reduced matrix material to a recovery stage to recover the valuable component.

In some embodiments, the process further comprises subjecting the mining feedstock to a pre-treatment stage prior to the kinetic pulverization stage.

In some embodiments, the pre-treatment stage comprises at least one of: a coarse sizing stage, a chemical addition stage, a drying stage, a debris separation stage, and a magnetic separation stage.

In some embodiments, the process further comprises subjecting the pulverized material to a post-treatment stage.

In some embodiments, the post-treatment stage comprises at least one of: a chemical addition stage, a heating stage, a debris separation stage, an electrostatic separation stage, and a dust collection stage.

In some embodiments, the debris separation stage comprises subjecting the pulverized material to flotation separation.

### BRIEF DESCRIPTION OF THE DRAWINGS

FIG. 1 is a process flow diagram for extracting a valuable component from a mined feedstock including a kinetic pulverization stage.

FIG. 2 is a process flow diagram for extracting a valuable component from a mined feedstock including a pre-treatment stage, a kinetic pulverization stage, a post-treatment stage and an extraction stage.

FIG. 3A is a process flow diagram for extracting a valuable component from a mined feedstock including a kinetic pulverization stage.

FIG. 3B is a process flow diagram for size reducing a mined feedstock and homogenizing with an additive to make an end product.

FIG. 3C is a process flow diagram for size reducing a mined feedstock and to produce a raw material stream comprising a raw material, including a kinetic pulverization stage.

FIG. 4 is a left-side perspective view of a pulverizing apparatus, showing a motor and a housing for the pulverizing apparatus, according to an embodiment.

FIG. 5 is a right-side perspective view of the pulverizing apparatus illustrated in FIG. 2, showing an outlet proximate the bottom end of the housing.

FIG. 6 is a bottom perspective view of the pulverizing apparatus illustrated in FIG. 2, showing a belt connection connecting the motor and a rotatable shaft.

FIG. 7 is a section view of the housing illustrated in FIG. 5, showing the rotatable shaft and rotors positioned within the housing.

FIG. 8 is a partially exploded view of the housing for the pulverizing apparatus illustrated in FIG. 4.

FIG. 9 is a top sectional view of the housing for the pulverizing apparatus illustrated in FIG. 4, showing a plurality of deflectors spaced about the rotatable shaft along the housing sidewall.

FIG. 10 is a section view of the housing shown in FIG. 7 with the rotatable shaft and rotors removed therefrom, showing shelves positioned along the sidewall at different levels within the housing.

FIG. 11 is a partially sectioned view of a pulverizing rotor mounted within the housing for the pulverizing apparatus illustrated in FIG. 4, showing the vortices created within the housing.

FIG. 12 is a schematic top view of the housing according to an embodiment, showing overlapping vortices within the interior chamber of the housing.

FIG. 13 is a schematic view of a kinetic pulverizer system that includes multiple units for treating the mining feedstock.

FIG. 14. is a process flow diagram for treating a mining feedstock comprising geological materials using kinetic pulverization followed by screening, and also including a magnetic separation stage and a dust collection stage.

FIG. 15 is a process flow diagram for treating a mining feedstock comprising geological materials using kinetic pulverization followed by screening, and also including a dust collection stage.

FIG. 16 is a side view schematic of an example magnetic separation stage.

FIG. 17 is a side view schematic of another example of a magnetic separation stage.

### DETAILED DESCRIPTION

Processing and extraction of valuable components from mining feedstocks can be enhanced by the use of a kinetic pulverization stage to facilitate size reduction of the mining feedstock. The kinetic pulverization stage can be one-pass where the feed material passes through a kinetic pulverizer to produce a pulverized output stream that is then processed downstream to extract valuable components. In some embodiments, the pulverized output stream can be classified by size with larger particle sizes being optionally re-introduced to the kinetic pulverization stage and the smaller sized material being subjected to extraction to recover the valuable components.

It is also possible to subject the material to multiple passes through one or more kinetic pulverizers. The high-energy, self-collision mechanisms of kinetic pulverization can enable collisions of feedstock lumps and particles to facilitate efficient size reduction and energy input notably greater than conventional mills, to produce a pulverized material with properties including particle size distribution suitable for subsequent extraction of valuable components.

In one example, the mining feedstock is a lithium-bearing clay ore that is subjected to the kinetic pulverization stage followed by extraction of lithium from the size-reduced pulverized material. The extraction can include a leaching stage using acid or water to produce a lithium enriched leachate, which is then subjected to lithium recovery to produce the lithium product. Various extraction methods can be used to extract the lithium from the pulverized material.

However, it is noted that various mining feedstocks can be subjected to kinetic pulverization followed by tailored extraction methods depending on the valuable component of interest, the properties of the feedstock matrix, and process design considerations. The kinetic pulverization stage can be operated to facilitate efficient energy input, rapid and efficient size reduction, mechanochemical processing of the mining feedstock, and enhanced extraction of the resulting pulverized material. It is noted that techniques described herein can be used in association with processes and systems described in patent application published as WO2021138345, which is incorporated herein by reference. For example, a kinetic pulverizer as described herein can be used for processing clay minerals instead of or in addition to size-reduction and/or milling units described in WO2021138345.

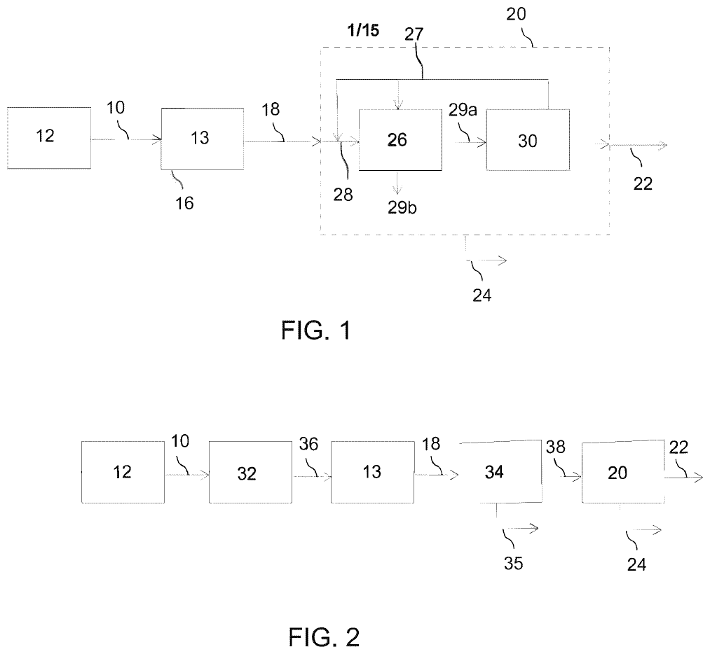

Referring now to FIG. 1, a mining feedstock 10 that is derived from a mining operation 12 is provided to a kinetic pulverizer 16 for a kinetic pulverization stage 13 to produce a pulverized output material 18. The pulverized output material 18 can then be further handled and processed, as will be describe in detail below. In general, at least a portion of the pulverized output material 18 is subjected to an extraction stage 20 to recover one or more valuable components 22 present in a valuable component enriched steam and a reject material 24 in a valuable component-depleted stream. In some embodiments, the reject material 24 can comprise gangue materials. The extraction stage 20 can include various steps and treatments depending on the nature of the feedstock and the components to be extracted. In some implementations, the extraction stage 20 can include a leaching stage 26 where a leaching liquid 27 is added to the pulverized material 18 to produce a leachate 28 that is enriched in the target component, followed by a recovery stage 30 where the leachate 28 is processed to recover the valuable component 22 from the liquid, which can be recycled as leaching liquid 27.

Turning to FIG. 2, the process can also include one or more pre-treatment stages 32 as well as one or more post-treatment stages 34 with respect to the kinetic pulverization stage 13. For example, the pre-treatment stage 32 can include coarse sizing stage (e.g., using a crusher), a chemical addition stage, a drying stage, and/or debris separation stage, to produce a pre-treated feedstock 36. When the raw mined material includes larger lumps, it may be desirable to perform a coarse sizing stage to rapidly reduce the size of larger lumps down to smaller lumps that can be easily transported by solid handling equipment, such as conveyors, to the pulverizer. For example, the coarse sizing stage can include size reducing the mining feedstock with a secondary size reduction machine, such as a crusher. In addition, the raw mined material can have debris, such as wood or metal. Debris that is has higher flexibility and lower friability can be removed as it may not be size reduced and/or may not be desired in the main process stream. In addition, debris such as metal chunks could cause issues in the kinetic pulverizer and thus can be removed upstream. This pre-separation can include one or more methods, such as magnetic separation, manual separation, and other techniques.

In terms of chemical addition, the mining feedstock can be contacted with various additives designed to liberate the valuable component 22. The pre-treatment stage 32 can also include drying or dewatering if the feedstock has a certain moisture content. A dewatering stage can be suitable for feedstocks that are initially in paste or slurry form, such as byproduct streams, to remove water and produce a solid enriched feed material that is supplied into the KP 16. In a preferred embodiment, the moisture content of the mining feedstock 10 is not more than 50%, 40%, 30% or 20%. The feed material to the kinetic pulverizer can be provided with a water content between 10% and 35%, and the water content can be controlled using addition of water and/or drying of the feed material depending on its initial moisture content.

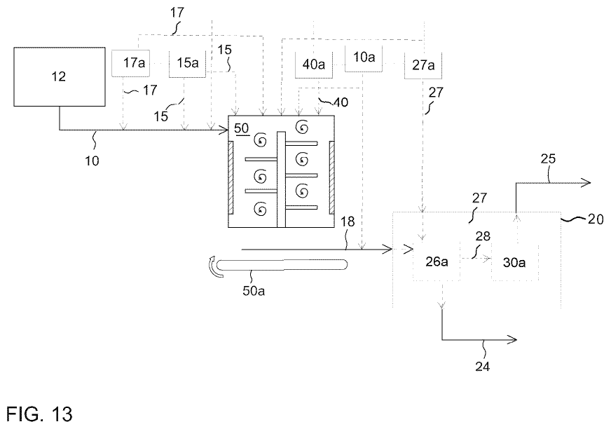

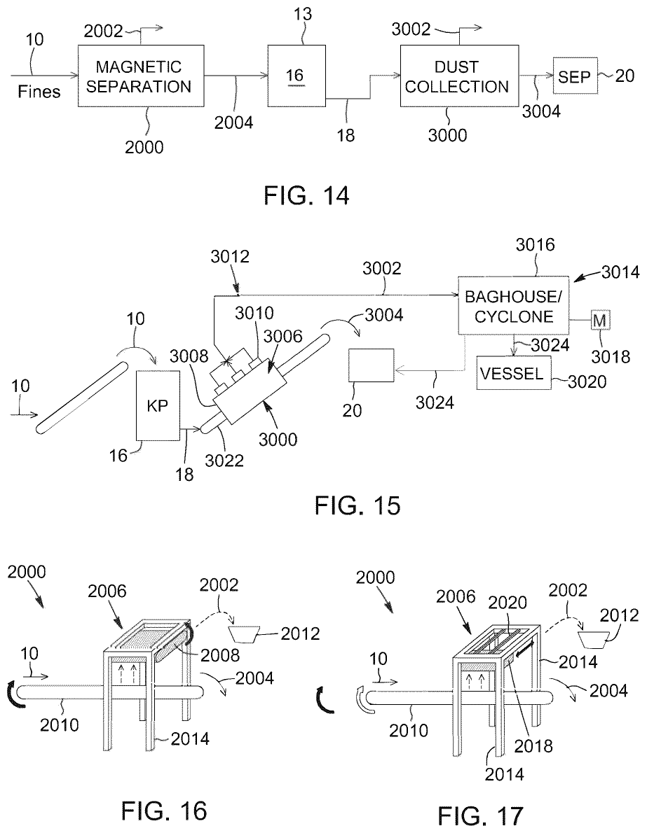

Still referring to FIG. 2, the post-treatment stage 34 can include a dust collection stage, a chemical addition stage, a heating stage, a debris separation stage, and/or a secondary size-reduction stage to produce a treated sized material 38 that is supplied to the extraction stage 20. The dust collection stage is also illustrated in further detail in FIGS. 13 and 14 and will be discussed below. The dust collection stage can be particularly useful for mining feedstocks that are dry and tend to generate fine dust particles.

The debris separation stage can be performed to remove larger material, including oversized ore and/or non-ore materials such as wood. The debris separation stage can be performed using a screen, such as a vibrating screen, a tumbler screen, a trommel screen, a gyratory screen, or a high frequency screen. Oversized material that does not include the target valuable component can be preferentially removed prior to extraction as the reject material 24. In some implementations, the debris separation stage can include flotation separation or a flotation process. For example, when the pulverized output material 18 is a homogenized output material and/or is effectively size reduced such that mechanical screening based on size is impractical or challenging, flotation separation or a flotation process can be used to separate or sort size-reduced particles in the pulverized output material 18 based on the particle's density. For example, a waste material 35, such as gangue material, can be separated from the material in the pulverized output material 18 that includes the valuable component 22 to produce the waste material 35 and the treated sized material 38.

Another potential post-treatment stage 34 is a heating stage for pre-heating the pulverized output material 18 in preparation for the extraction stage 20, which can apply particularly for extraction methods that are operated at higher temperatures. Furthermore, the post-treatment stage can include chemical addition, which can be tailored for the extraction methods to be used. For example, the pulverized output material 18 can be contacted with various additives designed to liberate the valuable component 22.

The post-treatment stage 34 can also include one or more secondary size-reduction stages to further size reduce or pulverize the pulverized output material 18 prior to the extraction stage 20. The secondary size-reduction stage can be performed in a kinetic pulverizer 16, in a secondary size-reduction machine, or in a combination of both. For example, in some implementations, the pulverized output material 18 can undergo a debris separation stage to categorize the materials in the pulverized output material 18 by size. Any oversized material (i.e., material not having the desired particle size for the extraction method being used on the mining feedstock 10) can be separated into an oversized fraction. The oversized fraction can then undergo a secondary size-reduction stage to size reduce the oversized fraction to the desired particle size for the extraction stage 20 and produce the treated sized material 38. In some implementations, the entire pulverized output material 18 can be treated with one or more secondary size-reduction stages. Conventional size reduction machines can be used in the secondary size-reduction stage, such as a ball mill, an oscillating motion mill, a hammer mill, a high shear energy mill, a vibratory mill, an attritor mill, a crusher, a grinding mill, etc. Alternatively, the oversized fraction and/or the pulverized material can undergo a secondary size-reduction stage in the same kinetic pulverizer as the kinetic pulverization stage or in a second or a series of kinetic pulverizers.

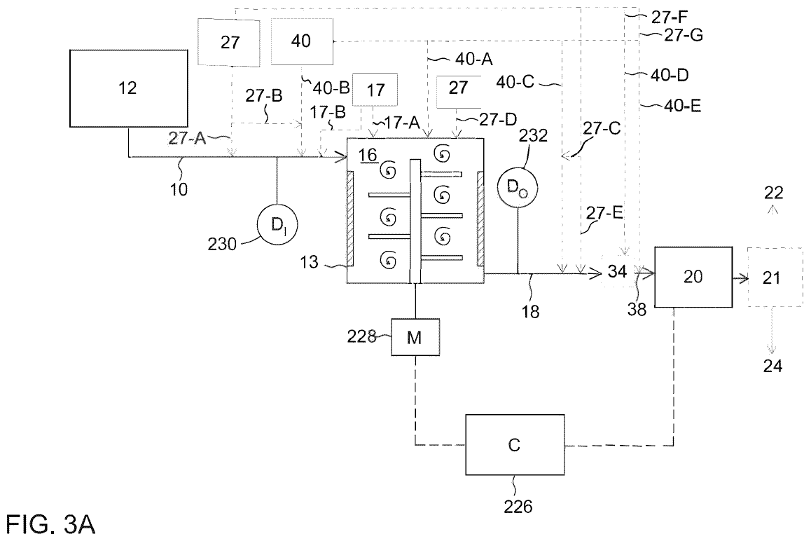

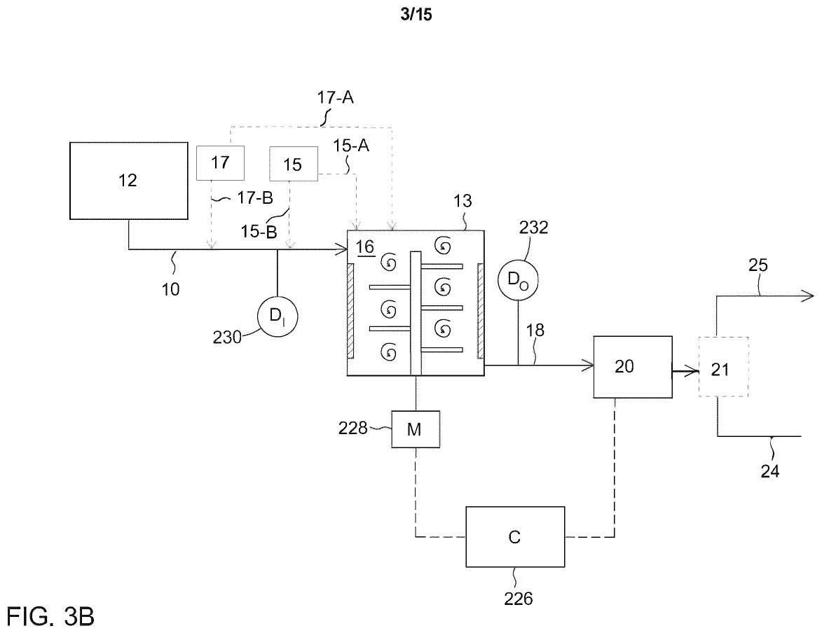

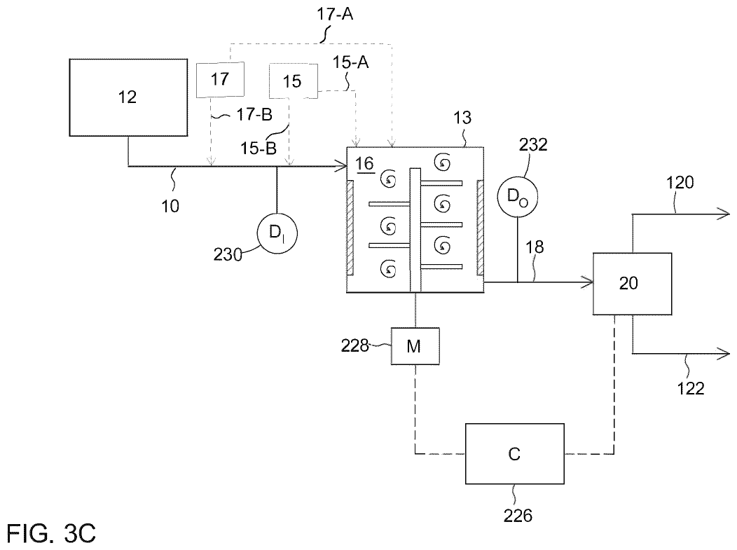

Turning now to FIG. 3A, as mentioned above, a chemical additive 40 can be used in the process upstream of the extraction stage 20. The chemical additive 40 can be selected and provided in an amount with respect to the main process stream based on various factors. In addition, the chemical additive 40 can be added before or during the kinetic pulverization stage 13 in a pre-treatment stage 32 or after the kinetic pulverization stage 13 in a post-treatment stage 34. The chemical additive 40 can be added to the mining feedstock 10 (see additive stream 40-B), to the kinetic pulverizer 16 (see additive stream 40-A), to the pulverized output material 18 before a post-treatment stage 34 (see additive stream 40-C), to the secondary size-reduction machine during a secondary size-reduction post-treatment stage 34 (see additive stream 40-D), and/or to the treated sized material 38 after the post-treatment stage 34 (see additive stream 40-E).

The additive streams can be provided in various forms depending on the nature of the chemical, the main process stream into which the chemical additive is contacted, and other factors. For example, the additive stream can be in the form of a particulate solid, liquid, slurry or emulsion; and it can be sprayed, dripped, pump-fed or gravity-fed into the process. For example, the mining feedstock 10 can be supplied to the kinetic pulverizer 16 via as a solid material provided on a feed conveyor and the chemical additive 40 can be sprayed as a liquid over the top surface of the mining feedstock 10 during conveyance or can be added as a solid powder or particulate material that is deposited or spread on top of the mining feedstock 10. In such scenarios, the mining feedstock 10 and the chemical additive 40 would be co-fed into the kinetic pulverizer 16 for processing.

The mining feedstock 10 can include one or more materials from geological sources and includes with one or more valuable components targeted for extraction. The valuable component can be embedded or otherwise held within the matrix of the material. The mining feedstock 10 can be a raw mined material supplied directly from a mine, a pre-treated mined material, and/or a byproduct of a mining process such as oversized material from other separation processes. The mining feedstock 10 can also be a mixture of several materials from different sources and having different properties. The process parameters can be adapted based on the nature of the matrix and the valuable component.

The mining feedstock 10 can be obtained from a mining site at which the kinetic pulverizer is located, or the mining feedstock 10 can be obtained and transported to another location for the kinetic pulverization stage 13 and the extraction stage 20. The composition of the mining feedstock 10 can vary and will depend on the type of mining operation, grade of the mined ore, among other factors. For example, the mining feedstock 10 can include ore, rocks, minerals, slag, clinker, petroleum coke, clay minerals, oversized streams, reject streams and/or soil minerals that are generated at a mining and extraction operation. The valuable component can include metals as well as other species.

In some embodiments, the valuable component 22 includes lithium and the mining feedstock 10 includes lithium-bearing clay mineral. In such case, the lithium-bearing clay mineral can be contacted with a cation source (e.g., NaCl), followed by kinetic pulverization, and then followed by a leaching stage 26 to obtain a lithium-rich leachate. In other scenarios, the valuable component is at least one metal in an ore having a clay-rich matrix, and the mining feedstock is processed in a similar manner with the addition of a cation source, kinetic pulverization, and leaching. The metal can be present within the ore depending on the composition and crystal structures of the ore.

It is also noted that the mining feedstock 10 can be obtained from various mining operations, such as coal mining, metal ore mining, nonmetallic mineral mining, oil sands mining, quarrying, etc. The mining feedstock 10 typically includes hard, brittle, friable lumps such that the kinetic pulverization facilitates breakage and notable size reduction, converting the mining feedstock into pulverized material that includes a sized reduced fraction and possibly an oversized fraction. For instance, if the mining feedstock 10 includes materials that are non-friable and/or flexible, these may not be sized reduced and can make up the oversized fraction of the pulverized material withdrawn from the pulverizer. The oversized fraction can be separated from the sized reduced fraction by screening prior to extraction, if desired. The mining feedstock can include a mixed material that includes material containing valuable components but also debris or unwanted material that can be handled by the KP 16 and be either size reduced or separated depending on the nature of the debris. The versatility of the KP 16 within the overall process for processing mining feedstocks and extracting valuable components is notable as it can receive multiple types and mixtures of feed materials.

In the kinetic pulverizer 16, the mining feedstock 10 can be size-reduced, for example to sand or silt sized particles, and can optionally be homogenized with any additives that were added upstream. Thus, the pulverized output material 18 can include the sized reduced fraction and optionally one or more chemical additives 40. In some embodiments, the ultra-high impact energy of the kinetic pulverizer 16 produces a finer particle size than a conventional ball mill and imparts higher energy to the material, which can have mechanochemical effects. In other embodiments, the pulverized output material 18 can be further size reduced in a secondary size-reduction machine, such as a conventional ball mill.

In an example implementation, the mining feedstock 10 includes metal-containing minerals having a stable mineral structure that makes it difficult to extract valuable metals efficiently. By subjecting the metal-containing minerals to kinetic pulverization, mechanochemical activation can be introduced to activate the transformation of inert structures (e.g., M-O coordination structures, where M is a metal such as Li) in the present of an additive, such as potassium sulfate. This pulverization-induced mechanochemical activation can then be followed by leaching using a dilute acid leaching liquid to facilitate separation of the metal. While mechanochemical treatments have been used in some contexts for activating minerals to enhance extraction, it has typically involved an exclusive step of ball milling, which can have drawbacks. Kinetic pulverization provides very high energy collisions between particles of the material and can facilitate enhanced mechanochemical activation by leveraging a relative impact energy of particle collisions that can be two to three orders of magnitude greater than a large conventional ball mill used in mining at scale. For example, as shown in Table 1 below, the maximum linear speed at vortex collisions can reach 41% to 54% of the speed of sound when the kinetic pulverizer 16 is operated at between 850 and 1100 RPM. The kinetic pulverizer can be operated to provide certain target levels of mechanochemical activation depending on the feed material, by modifying operating conditions, such as rotation speed and chemical addition.

In some implementations, the kinetic pulverizer 16 can be operated to size reduce the feed material such that the pulverized material includes micron sized and/or sub-micron sized particles in the size reduced fraction, which in turn can provide a greater total surface area that is exposed to the chemical additives 40 and enhance the extraction stage 20. The performance enhancements of the extraction stage 20 can include increased total yield of the recovered valuable components, increased efficiency, and/or increased throughput of the extraction process. In some embodiments, the kinetic pulverization stage 13 generates a pulverized material 18 that has granulometric properties ranging from dust-sized particles to larger particles, with the majority (e.g., over 50%, 55%, 60%, 65%, 70%, 75%, 80%, 85%, or 90%; or between 50% and 95%, 60% and 90%, or 65% and 85%) passing through a ⅜ inch sieve. The particle size distribution can vary depending on the size and physical characteristics of the feed material as well as the processing rotation speed of the kinetic pulverizer. It is also noted that the pulverized output stream can be screened to produce at least two fractions, which the larger fraction being recycled back into the feed and/or being sent to a secondary size reducing device and the smaller fraction being supplied to the extraction stage.

Once the mining feedstock 10 has been pulverized and the chemical additive 40 has optionally been admixed, the valuable component can be extracted from the mixture in the extraction stage 20 that can include a leaching stage 26 using the leaching liquid 27, as generally shown in FIG. 1. The leaching stage 26 can include acid leaching, water leaching, solvent assisted leaching, or another type of leaching depending on the materials involved. The leaching stage 26 can also be performed in conjunction with heating activation, if desired. The leachate 28 can then be fed to the recovery stage 30, which recovers the valuable component from the leachate 28. The recovery stage 30 can utilize various methods, such as crystallization, purification, among others. It is noted that one target component can be obtained as the final product of the valuable component 22, or multiple components can be recovered from the leachate 28. For example, a first metal could be crystallized out of solution from the leachate 28 in a first recovery stage, and then the remaining liquid could be subjected to a second recovery stage to recover a second metal.

The extraction stage 20 can include the addition of the leaching liquid 27 in various ways. For example, the leaching liquid 27 can be added at least in part to the feed and/or to the leaching vessel separately from the pulverized material. In some embodiments, the extracted valuable component (e.g., metal such as Li) is one that has undergone ion-exchange with the chemical additive 40 (e.g., cation source that can come from NaCl) to create a solute or aqueous solution with the leaching liquid 27, although other mechanisms for liberating the valuable component may be used.

The valuable component can include various elements or compound present in the mining feedstock. For example, in some embodiments, the valuable component can include lithium, sodium, potassium, aluminum, silicon, magnesium, calcium, iron, nickel, and/or oxygen. In other embodiments, the valuable component can include carbon-based compounds such as graphene; or rare earth minerals, such as neodymium, yttrium, cerium, scandium, lanthanum, praseodymium, promethium, samarium, europium, gadolinium, terbium, dysprosium, holmium, erbium, thulium, ytterbium, and/or lutetium.

Referring to FIG. 3A, the leaching liquid 27 can be introduced directly to the feedstock 10 prior to the pulverization stage 13 (stream 27-A). The leaching liquid 27 and the chemical additive 40 can be admixed with the mining feedstock 10 concurrently, before (stream 27-B) and/or after (stream 27-C) the pulverization stage 13. In some embodiments, the leaching liquid 27 can be introduced into the kinetic pulverizer 16 directly as an independent stream (stream 27-D) or mixed with the pulverized output material 18 after the kinetic pulverization stage 13 (stream 27-E). In some embodiments, the leaching liquid 27 can be introduced during the post-treatment stage 34 (stream 27-F), such as into a secondary size reduction machine, or admixed directly with the treated sized material 38 prior to the extraction stage 20 (stream 27-G). In other words, the leaching liquid 27 can be admixed with the feedstock 10 (see stream 27-A), the chemical additive 40 prior to being provided to feedstock 10 (see stream 27-B) and/or when being admixed with the pulverized output stream 18 (see stream 27-C), directly to the kinetic pulverizer 16 (see stream 27-D), with the pulverized output stream 18 (see stream 27-E), directly to a secondary treatment device (see stream 27-F), and/or admixed with the treated sized material 38 (see stream 27-G).

The leaching liquid 27 can include various liquids selected to extract the valuable component from the matrix material of the pulverized material. The extraction mechanisms can vary and can include dissolution of the component or dissolution a solute facilitated by interaction of the component with cations, for example, to form an enriched leachate solution. In some embodiments, the leaching liquid 27 can include, consist essentially of, or consist of water, and the water based leaching liquid could include water obtained from a process operation, fresh water sources, make sup water, recycled water from the recovery stage, and so on. In some embodiments, the leaching liquid 27 can make up between about 20% wt and about 25% wt of the mixture when the leaching liquid 27 is added in stream 27-A or stream 27-B (i.e., added prior to the kinetic pulverization stage 13). For example, 1 part water can be added in stream 27-A or 27-B for every 3 to 4 parts of mining feedstock 13. In other embodiments, for example, when the leaching liquid 27 is added after the kinetic pulverization stage in streams 27-E, 27-F, 27-G, a larger amount of leaching liquid can be used, such as between 5% wt and 80% wt, or between 20% wt and 25% wt.

In some embodiments, when the leaching liquid 27 is mixed with the chemical additive 40 prior to being introduced into the mining feedstock 10 (stream 27-B) or the pulverized output stream 18 (stream 27-C), the chemical additive 40 solute dissolves in the leaching liquid 27 to form an aqueous solution. When the chemical additive 40 in the chemical additive-solvent solution comes into contact with the valuable component 22 in the geological material and undergoes ion exchange, a valuable component rich leachate 28 is produced. The valuable component rich leachate 28 can then be isolated from the geological material in the mining feedstock 10 via an extraction stage 20 that can comprise a leaching stage 26 to produce a valuable component-rich stream 29a and a valuable component-depleted stream 29b. The valuable component-rich stream 29a can then be subjected to a recovery stage 30 to isolate the valuable component 22.

The extraction stage 20 can be performed in one or more stages, and can use a variety of separation equipment. For example, the leaching liquid 27 can be admixed in one or more of the streams 27-A to 27-G, to leach the valuable component rich leachate 28 out of the geological material in the mining feedstock 10. In some embodiments, the leaching liquid 27 can be admixed in all of the streams 27-A to 27-G. In some embodiments, the last solvent wash, such as at streams 27-E, 27-F, and/or 27-G, can include one or more agitation stages. The agitation stage can comprise the mixture of pulverized output stream 18 or the treated sized material 38, the chemical additive 40, and the leaching liquid 27 being agitated to increase the liberation of the valuable component 22 into the valuable component rich leachate 28. In some embodiments, the agitation can be at a higher temperature than room temperature, such as between about 60° C. and about 100° C., or about 90° C. In some embodiments, the agitation can be conducted in a conventional agitator, such as a mechanical agitator or magnetic agitator, operated at between about 800 rpm and about 1200 rpm, or about 1000 rpm for at least 10 minutes.

To filter or leach the pulverized output stream 18, various types of filters or screens can be used, such as a liquid filtration screen, a vibrating screen, a tumbler screen, a trommel screen, a gyratory screen, a high frequency screen, etc. In some embodiments, the mechanical screening can be performed using classification equipment, such as classifiers that sort materials according to their size, shape, and/or density, including, without limitation, air classifiers and hydrocyclones. Other types of separation or filtration equipment can also be used. valuable component rich leachate 28 is separated or filtered from the geological material in the mining feedstock 10, the valuable component 22 can be isolated from the valuable component rich leachate 28 with a recovery stage 30.

When a chemical additive 40 is used to liberate a valuable component 22 from the geological material in the mining feedstock 10, the pulverized output stream 18 can comprise the geological material deprived of the valuable component 22 and a valuable component rich leachate 28. In some embodiments, the pulverized output stream 18 can undergo additional leaching stages 26 or agitation stages to separate the valuable component rich leachate 28 from the geological material.

In some embodiments, a friable additive 17 can be introduced into the mining feedstock 10 concurrently with (stream 17-A) or prior to (stream 17-B) the kinetic pulverization stage 13 such that the friable additive 17 is size reduced and is homogenized with the geological material in the mining feedstock 10 to form part of the pulverized output stream 18. In some embodiments, the friable additive 17 can be introduced directly into the kinetic pulverizer 16 as a separate stream from the mining feedstock 10 (stream 17-A).

Accordingly, the mining feedstock 10 can be fed directly to the kinetic pulverization stage 13 after being admixed with the chemical additive 40, the friable additive 17 and/or the leaching liquid 27. The leaching liquid 27 can be admixed with the mining feedstock 10 prior to the kinetic pulverization stage 13 because the kinetic pulverizer 16 is capable of effectively handling wet feed material. For example, the mining feedstock 10 can have a moisture content of up to 50% or between 10% and 40%, and can be fed directly into the kinetic pulverizer 16 to produce a pulverized output stream 18 comprising the mining feedstock 10 and the leaching liquid 27.

Referring now to FIG. 3B, a mining feedstock 10 comprising a geological material can be size reduced and homogenized with an additive 15 to produce an end product 25 and a reject material 24. The mining feedstock 10 can be admixed with the additive 15 concurrently with (stream 15-A) or before (stream 15-B) the mining feedstock 10 is introduced into the kinetic pulverizer 16. In some embodiments, the additive 15 can be introduced directly into the kinetic pulverizer 16 as a separate stream from the mining feedstock 10 (stream 15-A). In this embodiment, the pulverized output stream 18 can comprise a homogenized mixture of the pulverized geological material in the mining feedstock 10 and the additive 15. The kinetic pulverizer 16 substantially reduces the size of the geological material and homogenizes the mixture of pulverized geological material and the additive 15.

In some embodiments, the pulverized output stream 18 can undergo an extraction stage 20 to isolate the end product 25 from reject materials 24 in the pulverized output stream 18, such as particles that are too large and/or too small. During the extraction stage 20, one or more mechanical screens 21 can be provided to favour or maximize high purity or high yield of a particular desired size of the end product 25.

In some embodiments, the end product 25 can comprise a construction material, such as a cement mixture. The cement mixture can be processed using the kinetic pulverizer 16 by pulverizing clinker as the mining feedstock 10 and homogenizing with gypsum as an additive 15. The kinetic pulverizer 16 can therefore simultaneously pulverize and homogenize the clinker and gypsum mixture to produce a cement mixture end product. In some embodiments, the mining feedstock 10 can be mixed with a friable additive 17 to assist with pulverizing and creating a homogenous end product 25 that includes the friable additive 17.

Referring now to FIG. 3C, the kinetic pulverizer 16 can be used to produce a raw material stream 120 that comprises a raw material. The mining feedstock 10 comprising a geological material is introduced to the kinetic pulverizer 16 to undergo a kinetic pulverization stage 13 to pulverize and size-reduce the geological material to produce a pulverized output stream 18 that comprises a raw material faction and an impurities faction. The pulverized output stream 18 can then be subjected to an extraction stage 20 to produce a raw material stream 120 and an impurities stream 122. In some embodiments, the mining feedstock 10 comprises coal. The pulverized coal output can then undergo an extraction stage 20 to isolate the impurities and middlings (i.e., the impurities stream 122) from the purified coal (i.e. the raw material stream 120). During the extraction stage 20, the impurities stream 122 can be separated from the raw material stream 120 based on size and/or weight. For example, when the mining feedstock 10 comprises coal, the impurities stream 122 comprises impurities and middlings. As impurities are generally heavier than middlings and middlings are heavier than pure coal (i.e., the raw material stream 120), a gravity separator, such as mineral jig concentrators, heavy-media baths, washing tables, spiral separators, or cyclone separators can be used to separate the impurities stream 122 from the raw material stream 120. In some embodiments, a flotation process can be used to separate finer particles in the raw materials stream 120 from the impurities stream 122. In some embodiments, the raw material stream 120 and/or impurities stream 122 can be sorted and classified by size, with particle sizes that are larger than desired can be redirected to the kinetic pulverization stage 13.

In some embodiments, the mining feedstock 10 can be admixed with an additive 15 and/or a friable additive 17 in any of streams 15-A or 15B and streams 17-A and 17-B, respectively. In these embodiments, the pulverized output stream 18 would comprise a homogenized mixture of the pulverized geological material, which comprises a raw material faction and an impurities faction, and the additive 15 and/or the friable additive 17.

In some embodiments, the kinetic pulverizer 16 can be used to mechanochemically process a material to produce a product, such as metallic nanoparticles, catalysts, magnets, y-graphyne, metal iodates, nickel-vanadium carbide and molybdenum-vanadium carbide nanocomposite powders.

Regarding the kinetic pulverization stage 13, a single kinetic pulverizer 16 can be implemented and operated as a one-pass kinetic pulverization stage. For example, the mining feedstock 10 and optionally, the chemical additive 40, the additive 15, the friable additive 17, and/or the leaching liquid 27 can be fed into an upper part of the kinetic pulverizer 16, which includes a drum with baffles and an internal rotating stem with multiple arms that create vortexes within the drum chamber. The mining feedstock 10 passes into the vortices and experience self-collision for pulverization and size reduction of the geological material. The geological material passes to a bottom region of the kinetic pulverizer 16 and is expelled via a lower outlet as the pulverized output stream 18. The rotation speed can be operated between 500 RPM to 1,200 RPM, between 500 RPM and 1,300 RPM, between 500 RPM and 1,500 RPM, between 600 RPM and 1,100 RPM, or between 700 RPM and 1,000 RPM, and can be adjusted in response to other process parameters or maintained relatively constant.

In some embodiments, the rotation speed is adjusted to control the size and quality of the output material. As shown below in Table 1, the maximum linear speed at the pad tip of the baffles can range between 71.1 and 92.1 m/s when the kinetic pulverizer 16 is operated with a rotational speed of 850 to 1100 RPM, respectively. It is noted that these observed maximum linear speeds at the pad tips of the kinetic pulverizer 16 and at the vortices collisions are dependent on the size and interior geometry of the assessed kinetic pulverizer and thus are non-limiting. In some embodiments, the linear speed at the pad tips and vortices collision can be greater than or less than the observed speeds in Table 1.

TABLE 1

| Pad Tip Diameter | | | 62.93″ |
|---|---|---|---|
| Speed of sound in air at 20° C. | | | 343 m/s |
| | | Max linear speed | Max linear speed |
| | Max linear speed | at vortices | at vortices |
| | at pad tip | collision | collision (% of |
| RPM | (m/s) | (m/s) | speed of sound) |
| 850 | 71.1 | 142.3 | 41% |
| 950 | 79.5 | 159.0 | 46% |
| 1050 | 87.9 | 175.8 | 51% |
| 1100 | 92.1 | 184.1 | 54% |

In addition to the kinetic pulverization stage 13 enabling targeted size reduction of the geological material, the kinetic pulverization stage 13 can also facilitate the mechanochemical breakage of the geological material and, when the chemical additive 40 is admixed with the mining feedstock 10 concurrently with or before the kinetic pulverization stage 13, the kinetic pulverizer 16 provides additional energy to increase the selective liberation of the valuable component 22. For example, the chemical additive 40 can be a cation source, such as a salt compound, configured to undergo ion-exchange with the valuable component 22 being isolated. In some embodiments, the chemical additive 40 can comprise a cation source that includes a cation and an anion. In some embodiments, the cation in the cation source can comprise an alkaline metal and/or an alkaline-earth metal. The anion in the cation source can comprise halide, SO₄⁻ and/or NO₃⁻. In some embodiments, the cation source comprises at least one of NaCl, PCl₃, KCl, Na₂SO₄, K₂SO₄, MgSO₄, CaSO₄, NaNO₃, KNO₃, CaCl₂), MgCl₂, Ca(NO₃)₂, and Mg(NO₃)₂. The chemical additive 40 can be in a dry and/or powdered form and allow separation of the valuable component 22 in an aqueous solution with the leaching liquid 27 after the kinetic pulverization stage 13. In some embodiments, the chemical additive 40 can be mixed in solution with the leaching liquid 27 prior to being introduced to the mining feedstock 10, the pulverized output stream 18, and/or the treated sized material 38. Depending on the nature of the chemical additive and the method of introduction into the process stream, the chemical additive 40 can be added in dry form, as a solution, as an emulsion or as a dispersion, for example.

When the chemical additive 40 and the mining feedstock 10 comprising the geological material are introduced into the kinetic pulverizer 16 together, energy from the kinetic pulverizer 16 can enhance the rate and extent of the ion exchange between the cations in the chemical additive 40 and the valuable component 22 embedded or held within the geological material in the mining feedstock 10. Furthermore, when the kinetic pulverization stage 13 is conducted in an inert environment, such as in nitrogen gas, the rate and extent of the ion exchange between the cations in the chemical additive 40 and the valuable component 22 in the mining feedstock 10 can increase. An inert environment can be achieved with an inert chamber (not shown) operatively surrounding at least one of: the kinetic pulverizer 16, a pulverizer conveyor system operatively connected to the kinetic pulverizer 16, and a screen used during the extraction stage 20. The inert environment can comprise a hypoxic environment that is devoid or substantially devoid of oxygen. In some embodiments, the inert environment can comprise, consist of, or essentially consist of nitrogen gas.

When the mining feedstock 10 is introduced into the kinetic pulverizer 16, the kinetic pulverization stage 13 can facilitate the use of kinetic energy, vortices and matter-on-matter collisions to achieve size reduction of the geological material, homogenization of the pulverized output stream 18, liberation of the valuable component 22 when the chemical additive 40 is introduced into the kinetic pulverizer 16, and/or blend or homogenize the chemical additive 40, other additives such as an additive 15 or a friable additive 17, and/or a leaching liquid 27 that may be incorporated with the mining feedstock 10.

Once the pulverized output stream 18 is expelled from the lower outlet, the pulverized output stream 18 can be further processed to separate the size-reduced particles or to leach the valuable component 22 from the geological material in the mining feedstock 10. For example, the geological material can be separated from the valuable component rich leachate 28 during the extraction stage 20 using filtration or size-based separation techniques, such as screening. The screening can be performed using various types of mechanical screens, such as a liquid filtration screen, a vibrating screen, a tumbler screen, a trommel screen, a gyratory screen, a high frequency screen, etc. Alternatively, the mechanical screening can be performed using classification equipment, such as classifiers that sort materials according to their size, shape, and/or density, including, without limitation, air classifiers and hydrocyclones. The mechanical screen can be configured or operated based on the composition and size distribution of the pulverized output stream 18 to filter the valuable component rich leachate 28 from the pulverized geological material. In other embodiments, the screens can operate to sort the pulverized output stream 18 by size into multiple sized-based streams. Depending on the sized product to be produced, the screen and the kinetic pulverizer 16 can be operated and designed in certain ways to generate a product having a maximum or minimum size, for example. However, it is noted that the screen design can be market driven to provide various size distributions of the size-reduced material.

In some embodiments, the extraction stage 20 and the pulverization stage 13 are coordinated such that the operation of one can influence the other. For example, the screen or filter and the kinetic pulverizer 16 can be monitored and controlled via a controller 226 to achieve a desired parameter, such as certain properties of the pulverized output stream 18, the valuable component rich leachate 28, or the end product 25. For example, if a change in the mining feedstock 10 results in the kinetic pulverizer 16 generating a larger sized fraction in the pulverized output stream 18, the kinetic pulverizer 16 can be controlled, e.g., to increase the rotation speed by controlling the motor 228, to bring the sized fraction back to within a target range, such as a range to facilitate a desired liberation of the valuable component 22 or a desired range for the end product 25. Monitoring units or instrumentation, such as an inlet detector D_{I} 230 and an outlet detector D_{O} 232, can be provided to monitor properties of the incoming and outgoing streams, respectively, such as maximum or minimum size, size distribution, composition, mass, moisture content, and/or volume flow rates.

In some embodiments, the various streams are transported between the various stages using conveyor systems to facilitate continuous operation, although other transport methods can be used. The process can be continuous, batch feed, or operated according to other schemes depending on the facility and other factors.

Regarding the kinetic pulverizer 16, it is noted that the unit can have various structural and operational features. It some embodiments, the kinetic pulverizer can have one or more features as described in PCT/CA2019/050967, which is incorporated herein by reference.

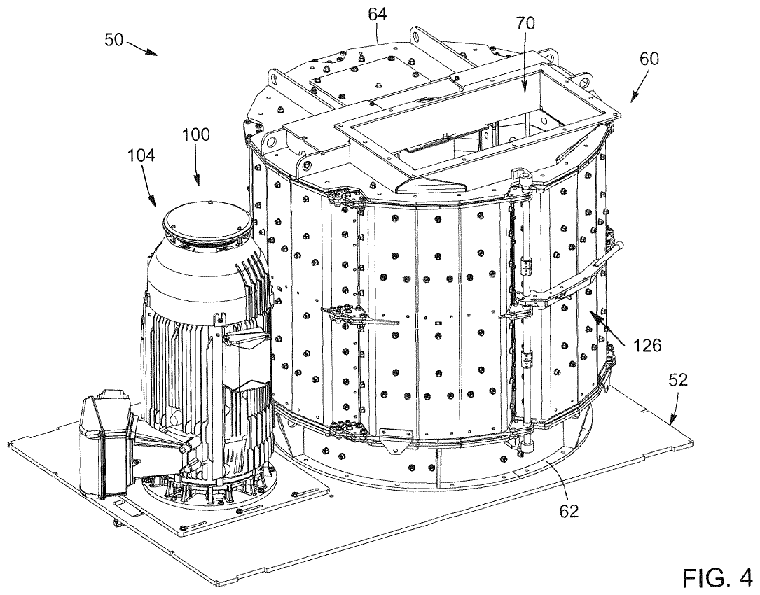

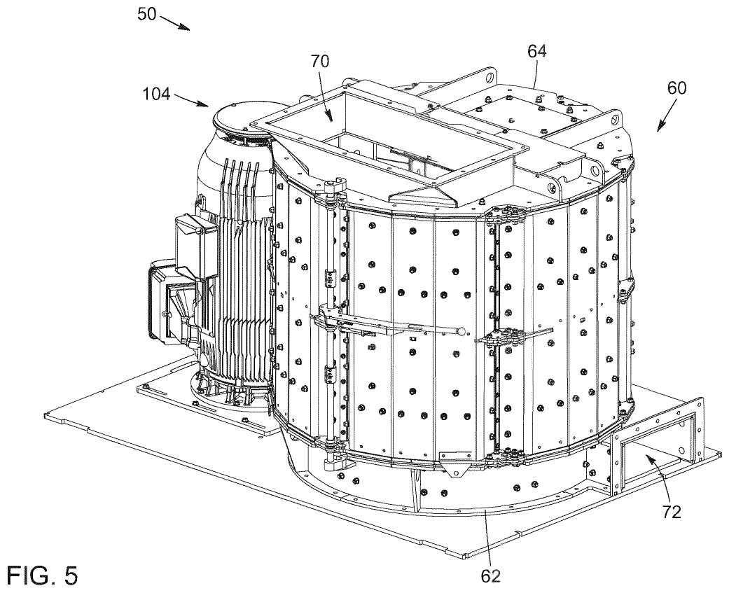

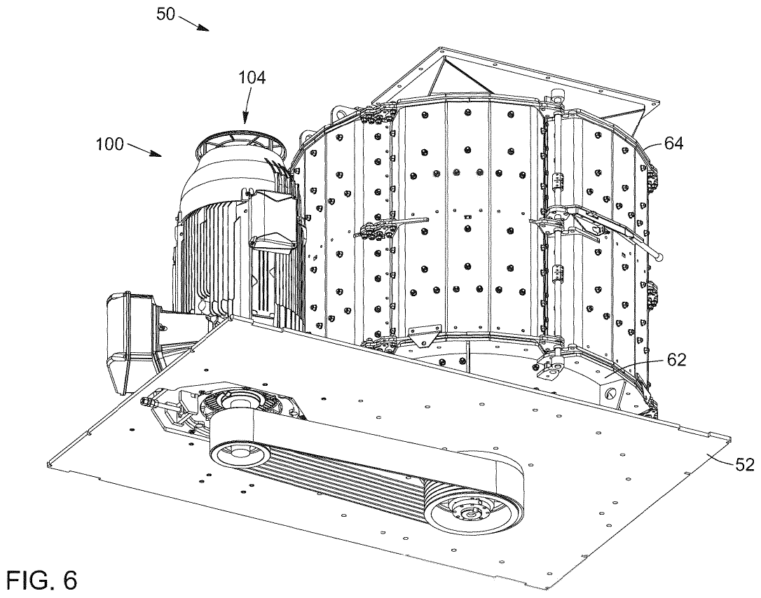

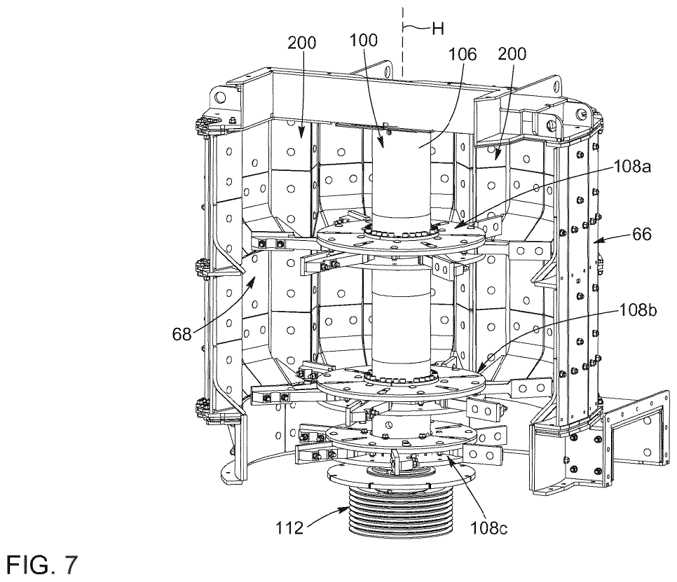

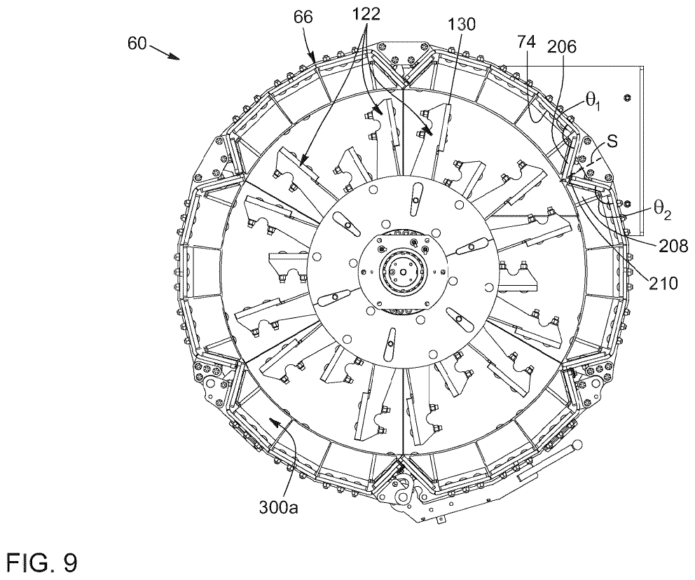

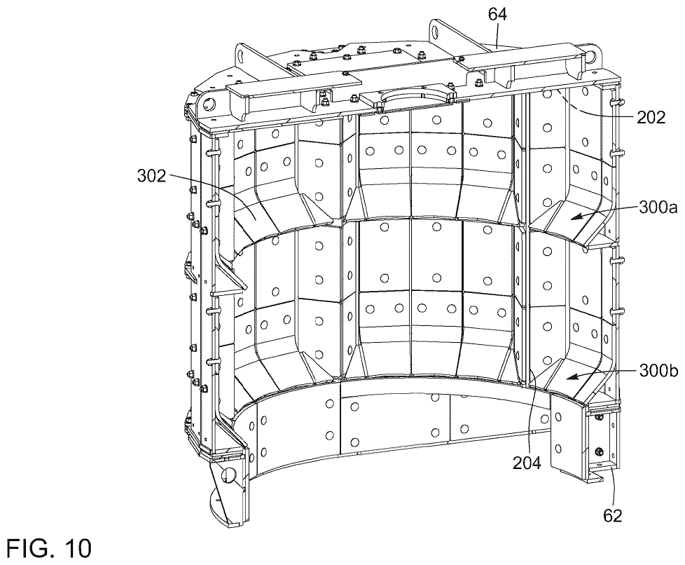

Referring now to FIGS. 4 to 11, there is shown a pulverizer 50, in accordance with one embodiment. The pulverizer 50 is adapted to receive an input material as described herein, such as the mining feedstock 10, and to pulverize or comminute the input material.

In the illustrated embodiment, the pulverizer 50 includes a base 52 and a housing 60 mounted over the base 52. Specifically, the housing 60 includes a bottom end 62 connected to the base 52 and a top end 64 opposite the bottom end 62. The housing 60 is hollow and includes a housing sidewall 66 extending between the top and bottom ends 64, 62 to define an interior chamber 68 in which the pulverization occurs. Specifically, the housing 60 includes an inlet 70 located at the top end 64 to receive the input material and an outlet 72 located at the bottom end 62 through which the pulverized material may be discharged once having been pulverized in the interior chamber 66. In the illustrated embodiment, the outlet 72 allows pulverized material to be discharged in a tangential direction to the housing sidewall 66. It will be understood that the outlet 72 may be configured differently. For example, the outlet 72 may be located in a bottom face of the housing 60 such that the pulverized material may be discharged in an axial direction downwardly from the housing 60. It will also be understood that alternatively, the outlet 72 may be positioned substantially towards the bottom end 62 but may not be positioned exactly at the bottom end 62 of the housing 60. Similarly, the inlet 70 may not be positioned exactly at the upper end 64 of the housing 60 and may instead be located generally towards the upper end 64.

In the illustrated embodiment, the housing 60 is generally cylindrical and defines a central housing axis H extending between the top and bottom ends 64, 62 of the housing 60. The housing 60 is adapted to be disposed such that the central housing axis H extends substantially vertically when the pulverizer 50 is in operation. In this configuration, the input material fed into the inlet 70 will ultimately tend to fall down towards the outlet 72 by gravity.

In the illustrated embodiment, the airflow generator 100 includes a pulverizing rotor assembly disposed within the interior chamber 68 and a rotary actuator 104 operatively coupled to the pulverizing rotor assembly for rotating the pulverizing rotor assembly to generate the airflow. Specifically, the pulverizing rotor assembly includes a rotatable shaft 106 located in the interior chamber 68 and extending between the top and bottom ends 64, 62 of the housing 60, along the central housing axis H, and a plurality of pulverizing rotors 108a, 108b, 108c secured to the rotatable shaft 106 so as to rotate about the central housing axis H when the rotatable shaft 106 is rotated.

Each pulverizing rotor 108a, 108b, 108c includes a rotor hub and a plurality of rotor arms 122 extending outwardly from the rotor hub and towards the housing sidewall 66. The rotatable shaft 106 extends through the rotor hub such that the rotor arms 122 are disposed in a rotation plane, which extends orthogonally through the central housing axis H. In this configuration, when the rotatable shaft 106 is rotated, the rotor arms 122 therefore remain in the rotation plane and move along the rotation plane. Alternatively, instead of all being disposed in a rotation plane, the rotor arms 122 could instead be angled upwardly or downwardly relative to the rotatable shaft 106. In yet another embodiment, the rotor arms 122 could instead be pivotably connected to the rotatable shaft 106 such that the rotor arms 122 could selectively be angled upwardly and downwardly as desired, either manually or automatically using one or more arm actuators.

In the illustrated embodiment, the plurality of airflow deflectors 200 includes six deflectors 200 which are substantially similar to each other and which are substantially evenly spaced from each other in an azimuthal direction (i.e. along a circumference of the housing sidewall 66) around the central housing axis H. Alternatively, all the deflectors 200 may not be similar to each other, may not be spaced from each other evenly and/or the pulverizer 50 may include more or less than six deflectors 202. For example, the pulverizer 50 may include between two and eight deflectors 200.

In the illustrated embodiment, each deflector 200 is elongated and extends substantially parallel to the housing axis H. Specifically, since the housing 60 is positioned such that the central housing axis H extends substantially vertically, the deflectors 200 also extend substantially vertically.

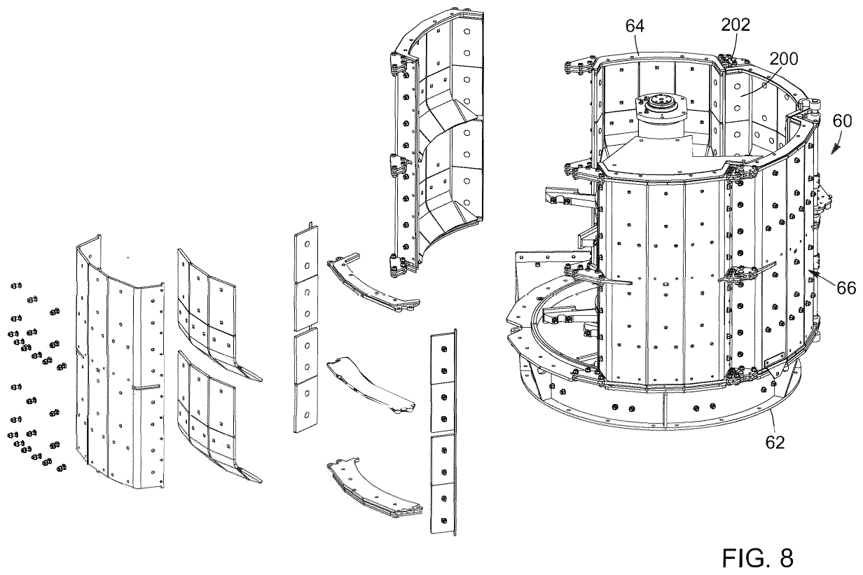

As best shown in FIGS. 8 to 10, each deflector 200 includes a top end 202 located towards the top end 64 of the housing 60 and a bottom end 204 located towards the bottom end 62 of the housing 60. In the illustrated embodiment, each deflector 200 is positioned so as to intersect the rotation plane of the upper pulverizing rotor 108a and of the intermediate pulverizing rotor 108c. More specifically, the top end 202 of the deflectors 200 is located above the upper pulverizing rotor 108a while the bottom end 204 of the deflectors 200 is located below the intermediate pulverizing rotor 108b and the deflector 200 extends continuously between its top and bottom ends 202, 204.

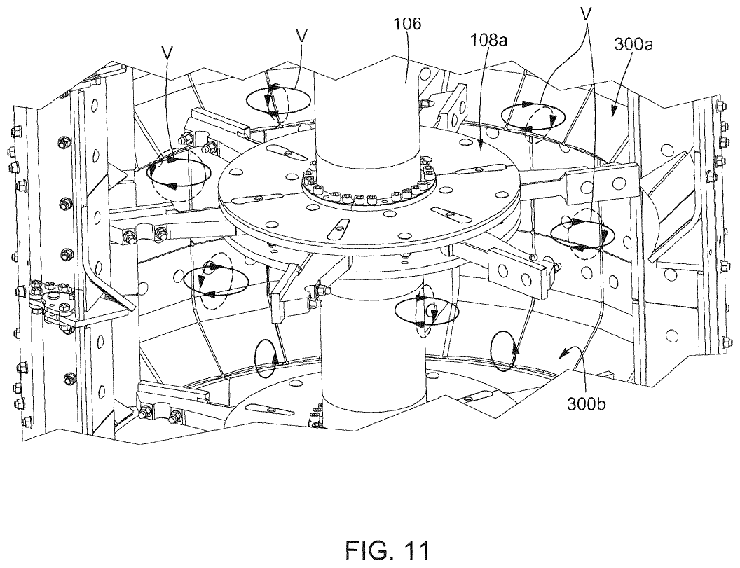

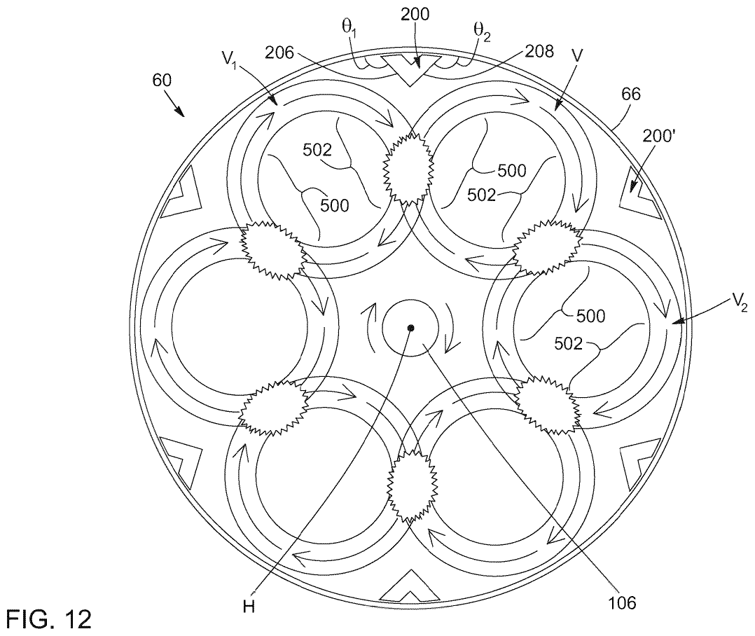

It will be understood that rotation of the rotor arms 122 will cause the air within the interior chamber 68 to move outwardly towards the housing sidewall 66. In the above configuration, since the deflectors 200 are horizontally aligned with the upper and intermediate pulverizing rotors 108a, 108b, the air will be moved outwardly by the upper pulverizing rotor 108a and intermediate pulverizing rotor 108b against the deflectors 200 to be deflected by the deflectors 200 to form the vortices V, best shown in FIGS. 11 and 12.

In the illustrated embodiment, each deflector 200 is generally wedge-shaped. Specifically, each deflector 200 has a generally triangular cross-section and includes a flow facing deflecting surface 206 which faces towards the airflow when the rotatable shaft 106 is rotated and an opposite deflecting surface 208 which faces away from the airflow. The flow facing deflecting surface 206 and the opposite deflecting surface 208 extend away from the housing sidewall 126 and converge towards each other to meet at an apex 210 which points towards the housing central axis H. The flow facing deflecting surface 206 is angled relative to an inner face of the housing sidewall 126 at a first deflection angle θ1 and the opposite deflecting surface 208 is angled relative to the inner face 74 of the housing sidewall 76 at a second deflection angle θ2.

In the illustrated embodiment, each deflector 200 is symmetrical about a symmetry axis S, which extends along a radius of the housing 60. In this embodiment, the first deflection angle θ1 is therefore substantially equal to the second deflection angle θ2. In one embodiment, the first and second deflection angles θ1, θ2 may be equal to about 1 degree to 89 degrees, and more specifically to about 30 degrees to 60 degrees. Alternatively, the deflector 200 may not be symmetrical and the first and second deflection angles θ1, θ2 may be different from each other.

In the illustrated embodiment, the apex 210 of each deflector 200 is spaced radially inwardly from the inner face 74 of the housing sidewall by a radial distance of about 7¾ inches or about 20 cm. Still in the illustrated embodiment, the apex 210 is further spaced radially outwardly from a tip 130 of the rotor arms 122 by a radial distance of between about ½ inch or about 1 cm and about 2 inches or about 5 cm. In one embodiment, the radial distance or “clearance space” between the tip 130 of the rotor arms 122 and the apex 210 may be selected such that the vortices V may be formed as desired when the rotatable shaft 106 is rotated.

Alternatively, the deflectors 200 could be differently shaped and/or sized. For example, the flow facing deflecting surface 206 and the opposite deflecting surface 208 may not be planar, but may instead be curved. In another embodiment, the deflectors 200 may not comprise an opposite deflecting surface 208. In yet another embodiment, instead of being wedge-shaped, the deflectors 200 may instead have a rectangular cross-section, or may have any other shape and size which a skilled person would consider suitable.

FIG. 12 is a schematic representation of the vortices V generated within the interior chamber 68 when the pulverizer 50 is in operation.

During operation of the pulverizer 10, the rotatable shaft 106 is rotated about the housing axis H such that the rotor arms 122 form the circular airflow revolving about the housing axis H. In the example illustrated in FIG. 12, the rotatable shaft 106 is rotated in a clockwise direction when viewed from above to form a counterclockwise airflow in the interior chamber 68.

The rotatable shaft 106 may be rotated at relatively high speed to provide the desired pulverizing effect in the pulverizer. In one embodiment, the rotatable shaft 106 is rotated at a rotation speed of between about 700 rpm and about 1500 rpm, or between about 700 rpm and about 1100 rpm, or more specifically at a rotation speed of between about 1000 rpm and about 1100 rpm. Alternatively, the rotatable shaft 106 may be rotated at a different rotation speed which would allow the formation of the vortices as described below.

The airflow travels generally along the inner face 34 of the housing sidewall 66, but is interrupted by the flow facing deflecting surface 206 of the deflectors 200 which cooperates with the rotor arms 122, and more specifically with the tip of the rotor arms 122 to form the vortices V. As shown in FIG. 12, the vortex V may further be guided back inwardly towards the central housing axis H by an adjacent deflector 200′.

Still referring to FIG. 12, each vortex V further overlaps at least one adjacent vortex V1, V2 to cause input material particles in suspension in the vortex V to collide with input material particles in suspension in the adjacent vortex or vortices V1, V2. More specifically, each vortex V created generally includes an outwardly moving portion 500 defined generally by airflow circulating from the shaft 106 towards the housing sidewall 66 and an inwardly moving portion 502 defined generally by airflow circulating from the housing sidewall 126 towards the shaft 106. As shown in FIG. 12, the outwardly moving portion 500 of each vortex V overlaps the inwardly moving portion 502 of a first adjacent vortex V1, and the inwardly moving portion 502 of each vortex overlaps the outwardly moving portion 500 of a second adjacent vortex V2.

In this configuration, the input material particles in the vortex therefore collide with input material particles moving at twice the movement speed of the particles in the vortex V. For example, in one embodiment, the vortices V, V1, V2 are rotating at about a third of the speed of sound. When input material particles from the first and second adjacent vortices V1, V2 collide with the input material particles in suspension in the vortex V, which move at the same speed but in the opposite direction, the particles will collide with each other at about two thirds of the speed of sound.

In one embodiment, in addition to the collision of the input material particles via the airflow and vortices V, the input material may further be pulverized by the rotor arms 122 impacting the input material particles in the interior chamber 68 as the rotatable shaft 106 is rotated. In this embodiment, the combined effect of the input material particles impacting each other in the overlapping vortices V, V1, V2 and of the rotor arms 122 impacting the input material particles may increase the efficiency of the pulverizer 50. Moreover, since the overlapping vortices V cause the particles to impact each other rather than surfaces inside the housing 20, the wear of the components inside the housing 20 may be reduced.

It will be understood that the vortices V illustrated in FIGS. 11 and 12 have been simplified for ease of understanding and that in practice, the vortices V may not be exactly circular as illustrated or be exactly located as indicated in FIGS. 11 and 12.

In the illustrated embodiment, the pulverizer 50 further includes a plurality of shelves 300a, 300b which extend inwardly from the housing sidewall 126. Specifically, the plurality of shelves 300a, 300b includes an upper shelf 300a and a lower shelf 300b spaced downwardly from the upper shelf 300a. Each shelf 300a, 300b extends circumferentially around the housing axis H and along the housing sidewall 126. It will be understood that the shelves therefore extend substantially orthogonally to the deflectors 200. Specifically, the deflectors 200 extend generally parallel to the housing axis H and can therefore be said to extend in an axial direction relative to the housing 60, while the shelves 300a, 300b can be said to extend in an azimuthal direction relative to the housing 60. In the illustrated embodiment, the deflectors 200 extend generally vertically while each shelf 300a, 300b is disposed in a generally horizontal plane and therefore extend generally horizontally.

Still in the illustrated embodiment, each shelf 300a, 300b extends substantially continuously around the housing sidewall 66. Alternatively, the shelves 300a, 300b may not extend continuously around the housing sidewall 66 and could instead include a plurality of shelf segments spaced from each other to define gaps between adjacent shelf segments.

In the illustrated embodiment, the upper shelf 300a is substantially horizontally aligned with the upper pulverizing rotor 108a and the lower shelf 300b is substantially horizontally aligned with the intermediate pulverizing rotor 108b. Alternatively, each shelf 300a, 300b could be located slightly below the corresponding pulverizing rotor 108a, 108b.

In the illustrated embodiment, each shelf 300a, 300b includes a top shelf face 302 which extends downwardly and away from the housing sidewall 66. Specifically, since the shelf 300a, 300b extends along the housing sidewall 66 and around the housing axis H, the top shelf face 302 is substantially conical. Still in the illustrated embodiment, the top shelf face 302 is angled relative to the housing sidewall 66 at an angle of between about 1 degree, where the top shelf face 302 would be almost flat against the housing sidewall 66, and about 89 degrees, where the top shelf face 302 would be almost orthogonal to the housing axis H. In one embodiment, the top shelf face 302 could be angled relative to the housing sidewall 66 at an angle of between 30 degrees to 60 degrees.

The shelves 300a, 300b are configured to deflect the airflow directed towards the shelf upwardly. This allows the input material particles to be temporarily maintained in suspension above the shelf 300a, 300b. The input material particles can therefore be subject to the effect of the vortices and to pulverization by impact with the rotor arms 122 for a longer period of time, resulting in additional reduction in the size and/or mechanochemical processing of the input material particles as they travel downwardly towards the next rotor stage or towards the outlet 72.

The upward deflection of the airflow may further contribute to the vortices V within the interior chamber 68. More specifically, as shown in FIG. 11, the vortices V may rotate in a plane generally parallel to the housing axis, i.e., upwardly-downwardly, in addition to rotating in a plane orthogonal to the housing axis H as illustrated in FIG. 12. The combined effect of the shelves 300a, 300b and the deflectors 200 therefore contribute to forming vortices V which are tridimensional such that air within the vortices V moves along a tridimensional path of travel, which may further promote collisions between the input material particles of adjacent, overlapping vortices V.

This configuration further allows the number of vortices V generated by the deflectors 200 to be multiplied by the number of shelves 300a, 300b in the housing 60. For example, in the illustrated embodiment, the pulverizer 50 includes six deflectors 200 which can form six vortices above each shelf 300a, 300b, for a total of 12 vortices in the entire interior chamber 68.

The pulverizer 50 can be designed and sized to handle the feedstock stream for one-pass processing. For example, the pulverizer can be sized to handle 5 to 40 tonnes per hour, or 20 to 40 tonnes per hour, of a feedstock stream that comprises a mixture of components as described above, while operating as a one-pass unit with a rotation speed between 500 RPM and 1,200 RPM, or between about 500 RPM and about 1,300 RPM, or between about 500 RPM and about 1,500 RPM to produce one or more of the output sized streams as described herein.

Referring now to FIG. 13, a system comprising a kinetic pulverizer 50, treatment units, a pulverizer conveyor system 50a, and an extraction unit 20a is shown. The system receives a mining feedstock 10 that is derived from a mining operation 12 is provided to the kinetic pulverizer 50 for a kinetic pulverization stage to produce the pulverized output material 18. In some embodiments, the kinetic pulverizer 50 comprises additional units, such as treatment units, to introduce a chemical additive 40, an additive 15, a friable additive 17, or a leaching liquid 27. For example, a chemical additive unit 40a, an additive unit 15a, a friable unit 17a, or a leaching liquid unit 27a can be operatively attached to the kinetic pulverizer 50 and configured to introduce a stream into the kinetic pulverizer 50 and/or into the other units. For example, the chemical additive unit 40a can be operatively connected with the leaching liquid unit 27a to facilitate admixing the chemical additive 40 with the leaching liquid 27 prior to introducing the chemical additive-leaching liquid mixture into the mining feedstock 10, the kinetic pulverizer 50, and/or the pulverized output stream 18. In some embodiments, the chemical additive unit and the leaching liquid unit can be operatively connected to an additional homogenization unit 10a configured to homogenize the chemical additive 40 and the leaching liquid 27 prior to being introduced into the mining feedstock 10, the kinetic pulverizer 50, and/or the pulverized output stream 18.

In some embodiments, the extraction unit 20a includes a leaching unit 26a and a recovery unit 30a. The leaching unit 26a can be configured to receive the pulverized material, incorporate the leaching liquid 27 into the pulverized material 18 and to produce a leachate 28 comprising the valuable component 22 and a reject material 24 rich in solids. In some embodiments, the recovery unit 30a can be configured to receive the leachate 28 from the leaching unit 26a and produce a valuable component 22 product and a depleted leaching liquid 27 that can be optionally recycled back into the leaching unit 26a.

Referring now to FIG. 14, in some embodiments the process includes a pre-separation stage comprising a magnetic separation stage 2000 or magnetic beneficiation upstream of a kinetic pulverization stage 13 to capture ferrous metal from the mining feedstock 10. The separated metal 2002 can be supplied as scrap metal for resale, can be used as a mining byproduct, or can be disposed of. The metal depleted mining feedstock 2004 can be fed to the kinetic pulverizer 16 for the kinetic pulverization stage 13. The magnetic separator can be designed and operated to remove tramp metal with a high weight density to reduce wear and damage on the KP. For example, the magnetic separator can be provided based on nominal size of the feedstock and ferrous objects that would be desirable for removal. For instance, the magnetic separator can be provided to ensure removal of solid ferrous objects that have a high weight in an overall low volume. While some geometries, such as flat sheets, may pose little concern to the operation of the KP, other geometries such as blocks, chunks, and the like can increase wear and damage and thus the magnetic separation stage 2000 facilitates removal to enhance downstream processing. The magnetic separator can be configured based on size of the feedstock, ferrous object size, and material burden depth. The magnetic separator could be actively controlled or simply turned on to enable the separation. The magnetic separation stage 2000 facilitates reduced risk of wear and damage to the kinetic pulverizer 16 during the kinetic pulverization stage 13, and also recovers scrap metal material.

The magnetic separation stage 2000 can use various types of magnetic separators, which can be selected based on the feedstock and throughput. For example, the magnetic separator can be a dry-type magnetic separator or wet type magnetic separator depending on the moisture content of the feedstock. The magnetic separator can have a magnetic field strength that is designed for removal of target ferrous metal objects that could be problematic for the kinetic pulverizer 16. The magnetic separator could also include a permanent magnet and electromagnetic magnetic separator. The magnetic separator can also have various design and structural features, e.g., drum type, roller type, disc type, ring type, belt type, among others. The magnetic separator can also use constant, alternating, pulsating, or rotating magnetic fields depending on the design and configuration of the system and the feedstock. The magnet itself can be composed of various materials.

While magnetic separation is a preferred mechanism to remove metals from the feedstock, there are various other metal removal methods that could be used instead of or in addition to magnetic separation. An additional metal removal stage could be designed to remove non-ferrous metals, for example, particularly metal debris that has a high weight density and are thus relatively heavy and thick. In some embodiments, the metal removal method (e.g., magnetic separation) is performed to remove all metal debris having an average diameter of 1 inch or greater. Metal debris that is lump shaped or elongated is removed, while metal debris that has a flat sheet shape is optionally removed.

Referring now to FIGS. 16 and 17, two example configurations are shows for the magnetic separation stage 2000. FIG. 16 shows a belt magnetic separator 2006 including a self-cleaning magnetic belt 2008 that is above a conveyor 2010. The magnetic belt 2008 discharges the ferrous metals into a bin 2012. The magnetic belt 2008 can be mounted to a magnet frame 2014 that spans across the conveyor 2010. FIG. 17 shows an alternative configuration including a stationary magnet 2018 on rails 2020 mounted above the conveyor 2010 and configured to move back and forth.

Referring back to FIG. 14, the system can also include a dust collection stage 3000 for recovering dust that is part of the pulverized output stream 18 exiting the kinetic pulverizer 16. The pulverized output stream 18 enters the dust control stage 3000, which recovers a dust stream 3002 and produces a dust reduced pulverized stream 3004 that can be fed to the extraction stage 20. The dust collection stage 3000 facilitates dust control and can include various units, such as a setting chamber and a baghouse or cyclone filtration unit.

Referring now to FIG. 15, the dust collection stage 3000 can include a dust collector 3006 that is coupled to the exit of the kinetic pulverizer 16, and may include a settling chamber 3008 that has dust outlets 3010 positioned on its top. The dust outlets can be in fluid communication via ducting 3012 to a dust recovery unit 3014 that includes a baghouse or cyclone filtration unit 3016 having a dedicated motor 3018. The dust recovery unit 3014 can also include a dust recovery vessel 3020 that receives the dust from the baghouse or cyclone filtration unit, for example via a hopper. In some embodiments, the dust collection stage can include a wet or dry electrostatic precipitator (ESP) that removes dust particles using electrostatic charges to separate small particles from the pulverized output stream 18.

The settling chamber 3008 can receive all of the output from the kinetic pulverizer 16 (the pulverized output stream 18) and thus receives relatively fine particles, which are deposited on an outfeed conveyor 3022 so that the pulverized material is added to the diverted output or redirected to the extraction stage 20. Fine particles settle on the outfeed conveyor 3022, while very fine dust particles are accumulated and withdrawn from the settling via the dust outlets 3010. The setting chamber 3008 can extend over a part or the entire length of the outfeed conveyor 3022 depending on the process design and the target level of dust control. The setting chamber 3008 can be in communication with the outlet of the kinetic pulverizer 16 via a flexible tubular member since the kinetic pulverizer 16 can experience vibration.

The quantity of dust in the pulverized output stream 18 is highly dependent upon the type and dryness of the feedstock supplied to the kinetic pulverization stage 13. In some embodiments, the fine recovered material 3024 can be treated with a chemical additive 40 and/or a leaching liquid 27 and be redirected to the extraction stage 20 to obtain the valuable component rich leachate 28.

It is noted that the power and suction of the dust collection stage 3000 can be adjusted to increase the amount of material capture in the dust collector. For example, the dust recovery unit 3014 can be controlled to provide a desired suction in the dust collector 3006. Therefore, the dust collection stage 3000 can be designed and operated to be a tool in the separation of the outbound material from the kinetic pulverization stage 13.

Still referring to FIG. 15, the baghouse filtration or cyclone filtration 3016 traps finer and lighter material, which can be stored in the vessel 3020. This fine recovered material 3024 can be added back into the diverted output stream, disposed of and/or kept as a fines product for sale. The fine recovered material 3024 can be recycled back into one or more stages of the system, such as the extraction stage 20 or the leaching stage 26. In some embodiments, the fine recovered material 3024 would be supplied into the dust reduced stream 3004 or the pulverized output stream 18 or would be kept as a distinct product stream that could be sold or mixed with other materials to provide a commercial product. It is noted that the recovered dust material can be treated, transported and used in various ways, some of which are described herein.

### Example Processes

A mining feedstock comprising lithium-enriched clay containing between about 0.5 and about 5 g/kg of lithium can be subjected to the process described herein. About 3% wt to 5% wt NaCl (Example 1) or about 3% wt to 5% wt MgCl₂ (Example 2) can be admixed with the lithium-enriched clay and the resulting mixture can be subjected to a kinetic pulverization stage in a kinetic pulverizer. Alternatively, lithium-enriched clay containing between about 0.5 and about 5 g/kg of lithium can be subjected directly to the kinetic pulverization stage and about 3% wt to 5% wt NaCl (Example 3) or about 3% wt to 5% wt MgCl₂ (Example 4) can be admixed with the pulverized output material during the leaching stage.

The kinetic pulverization stage can include a one-pass continuous flow process with the kinetic pulverizer being operated at a low rotational speed of 750 rpm or a high rotational speed of 1000 rpm. The pulverized output material exiting the kinetic pulverization stage can be subjected to one or more post-treatment stages. For example, the pulverized output material can undergo a debris separation stage, wherein the material is categorized by size to produce an oversize fraction. All of the pulverized output material, or if subjected to a debris separation stage, only the oversized material, can also be subjected to a secondary size-reduction stage. The secondary size-reduction stage can include subjecting the pulverized output material or the oversized material to about 2 to about 3 hours in a secondary size-reduction machine, such as a ball mill. The ball mill can be operated at approximately 500 rpm.

For all four examples, the pulverized output material exiting the kinetic pulverization stage or the treated sized material exiting the secondary size-reduction machine can be subjected to a leaching stage with 20% wt water added as the leaching liquid. The leaching stage can be conducted at 90° C. with agitation at 1000 rpm for 20 minutes. The resulting valuable component rich leachate is theorized to contain about 2.7 g/kg sodium lithium (NaLi) (Examples 1 and 3) or about 2.8 g/kg magnesium lithium (MgLi) (Examples 2 and 4), resulting in a lithium extraction efficiency of greater than 50%. It is theorized that the efficiency of the lithium extraction does not change substantively between processes where the chemical additive is added before or after the kinetic pulverization stage. Other elements are theorized to also be isolated from the lithium-enriched clay in each of Examples 1 to 4 in amounts indicated in Table 2.

TABLE 2

| Element | Concentration (ppm) in solution |
|---|---|
| Li | ≥100 |
| Al | ≤10 |
| Fe | ≤10 |
| K | ≤8000 |
| Ca | ≤3000 |
| Mg | ≤3000 |

1. A process for extracting a valuable component from a mining feedstock comprising geological materials embedded with the valuable component, the process comprising:
subjecting the mining feedstock to a kinetic pulverization stage wherein the mining feedstock is fed into a kinetic pulverizer and subjected to self-collisions created by vortices within the kinetic pulverizer to produce a pulverized material;
admixing the mining feedstock or the pulverized material with a chemical additive configured to selectively liberate the valuable component from the geological material; and
subjecting the pulverized material to an extraction stage to produce a valuable component-rich stream and a valuable component-depleted stream.

2. The process of claim 1, wherein the chemical additive comprises a cation source configured to undergo ion-exchange with the valuable component.

3. (canceled)

4. The process of claim 1, wherein the chemical additive is selected from the group consisting of NaCl, PCl₃, KCl, Na₂SO₄, K₂SO₄, MgSO₄, CaSO₄, NaNO₃, KNO₃, CaCl₂), MgCl₂, Ca(NO₃)₂, and Mg(NO₃)₂.

5. (canceled)

6. The process of claim 1, wherein at least one of:
the chemical additive is admixed with the mining feedstock concurrently with or before the mining feedstock is subjected to the kinetic pulverization stage;
wherein the chemical additive is introduced directly into the kinetic pulverizer concurrently with the mining feedstock and as a separate stream from the mining feedstock; and
wherein the chemical additive is admixed with the pulverized material after the mining feedstock is subjected to the kinetic pulverization stage.

7.-9. (canceled)

10. The process of claim 1, wherein a leaching liquid is introduced to at least one of: the mining feedstock, the kinetic pulverizer, the pulverized material, and the chemical additive and wherein at least one of:
the leaching liquid is introduced to the chemical additive, the kinetic pulverizer, and/or the mining feedstock at least one of: concurrently with and before the mining feedstock is subjected to the kinetic pulverization stage; and
the leaching liquid is introduced to at least one of: the chemical additive and the pulverized material after the mining feedstock is subjected to the kinetic pulverization stage.

11.-13. (canceled)

14. The process of claim 1, wherein the extraction stage comprises subjecting the pulverized stream to a leaching stage comprising separating the valuable component-rich stream from the valuable component-depleted stream.

15. (canceled)

16. The process of claim 14, wherein the valuable component-rich stream is separated from the valuable component-depleted stream with a mechanical screen, classification equipment, and/or a filter.

17.-22. (canceled)

23. The process of claim 16, wherein the classification equipment is an air classifier and/or a hydrocyclone.

24.-25. (canceled)

26. The process of claim 14, further comprising agitating a mixture of the pulverized material and the chemical additive with the leaching liquid to produce the valuable component-rich stream, wherein said agitation comprises at least one of:
agitating at a temperature between 60° C. and 100° C.;
agitating at a speed of between 800 rpm and 1200 rpm; and
agitating for at least 10 minutes.

27.-30. (canceled)

31. The process of claim 1, wherein the kinetic pulverization stage is conducted in an inert environment and/or wherein the chemical additive is admixed with the mining feedstock or the pulverized material in an inert environment.

32. (canceled)

33. The process of claim 31, wherein the inert environment substantially comprises a hypoxic environment or wherein the inert environment comprises nitrogen gas.

34. (canceled)

35. The process of claim 1, wherein at least one of:
the mining feedstock comprises at least one of ore, rocks, minerals, slag, clinker, petroleum coke, clay minerals, and soil minerals;
the valuable component comprises at least one of lithium, sodium, potassium, aluminum, silicon, magnesium, calcium, iron, nickel, oxygen, graphene, and rare earth elements; and
the mining feedstock comprises a lithium-rich clay mineral and the valuable component is lithium.

36.-60. (canceled)

61. The process of claim 1, further comprising subjecting the pulverized material to a post-treatment stage comprising at least one of: a chemical addition stage, a heating stage, a debris separation stage, an electrostatic separation stage, a dust collection stage, and a secondary size-reduction stage.

62. (canceled)

63. The process of claim 61, wherein at least one of:
the dust collection stage comprises recovering a dust fraction therefrom and producing a dust reduced pulverized stream;
the electrostatic separation stage comprises electrostatically separating particulate material from the pulverized material;
the secondary size-reduction stage comprises subjecting the pulverized material to a size reduction machine; and
the debris separation stage comprises subjecting the pulverized material to flotation separation.

64.-73. (canceled)

74. A process for producing a pulverized material comprising a homogenous mixture of a geological material derived from a mining feedstock and an additive, comprising:
providing the mining feedstock comprising the geological material;
admixing the additive with the mining feedstock;
subjecting the mining feedstock to a kinetic pulverization stage wherein the mining feedstock is fed into a kinetic pulverizer and subjected to self-collisions created by vortices within the kinetic pulverizer to produce the homogenous mixture of the geological material and the additive; and
withdrawing the homogenous mixture from the kinetic pulverizer;
wherein the additive is admixed with the mining feedstock concurrently with or before the kinetic pulverization stage.

75.-91. (canceled)

92. The process of claim 1, wherein the geological material is clinker and the additive is gypsum.

93. (canceled)

94. A system comprising:
a kinetic pulverizer configured to receive and process a mining feedstock comprising a geological material to produce a pulverized material;
a treatment unit for treating the mining feedstock, the pulverized material, and/or material within the kinetic pulverizer, the treatment unit being configured for:
incorporating a chemical additive, a leaching liquid, and/or a friable additive;
subjecting the mining feedstock to a pre-treatment; and/or
subjecting the pulverized material to a post-treatment;
a pulverizer conveyor system configured to transport the pulverized material downstream; and
an extraction unit configured to receive the pulverized material from the pulverizer conveyor system and extract a valuable component therefrom.

95. (canceled)

96. The system of claim 94, wherein the extraction unit comprises:
a leaching unit configured to receive the pulverized material, incorporate the leaching liquid into the pulverized material and to produce a leachate comprising the valuable component and a depleted material rich in solids; and
a recovery unit configured to receive the leachate from the leaching unit and produce a valuable component product and a depleted leaching liquid that can be optionally recycled back into the leaching unit.

97. The system of claim 96, wherein the recovery unit is configured to cause crystallization of the valuable component in the leachate and/or wherein depleted leaching liquid is treated and recycled back into the leaching unit.

98.-112. (canceled)

113. The system of claim 94, further comprising an inerting system operatively coupled to at least one of: the kinetic pulverizer, the pulverizer conveyor system, the treatment unit, and the extraction unit and wherein the inerting system is configured to provide hypoxic conditions and/or wherein the inerting system is configured to provide nitrogen gas for the inerting.

114.-134. (canceled)
